(19) United States
(12) Patent Application Publication
(10) Pub. No.: US 2021/0073765 A1
(43) Pub. Date: Mar. 11, 2021

(54) AUTOMATIC VENDING STORE

(71) Applicant: EnQi XU, Singapore (SG)

(72) Inventor: EnQi XU, Singapore (SG)

(21) Appl. No.: 16/958,179

(22) PCT Filed: Dec. 28, 2017
(86) PCT No.: PCT/SG2017/050653

§ 371 Date: Jun. 26, 2020

(51) Int. Cl. G06Q 20/20; G07F 11/16; G07F 11/62

(52) U.S. Cl. CPC G06Q 20/203; G06Q 20/208; G07F 11/62; G07F 11/1657

(57) ABSTRACT

An automatic vending store for dispensing one or more items or products to a consumer may include a storage section, a picker and a collection trough. The storage section may further include a plurality of storage compartments for storing different temperature sensitive items. A vending technician may replenish a plurality of item by scanning a machine readable code of the item and placing the items at designated storage compartments. The picker may pick the items and place the items according to a set of predetermined instructions to the appropriate storage compartments.

### CROSS-REFERENCE TO RELATED APPLICATIONS

This is a national phase of PCT Application PCT/SG2017/050653, which was filed on Dec. 28, 2017, the entire contents of which are fully incorporated herein by reference.

### TECHNICAL FIELD

The present patent application relates to an automatic vending store. The patent application also relates one or more methods for making, assembling, disassembling, installing, configuring, maintaining, repairing and using the automatic vending store.

### BACKGROUND

The present patent application or application relates to an automatic vending store. The automatic vending store includes one or more vending machines or automated machines, that possibly provide perishable and non-perishable items (i.e. products, goods of sales), usually as fast moving consumable items such as snacks, beverages, alcohol, cigarettes and lottery tickets to consumers or customers. Yet, there is another type of known vending machine that provides novelty items. An item of the other type of vending machine is dispensed after either money is inserted into the machine, or other forms of payment modes are accepted and approved. Each of these known vending machines has limited storage space of items therein. To provide wide range of products or goods of sales, multiple pieces of these known vending machines are lined up side by side. However, the side by side arrangement also presents a problem during replenishment and collection of cash payment at the multiple pieces of known vending machines. A human operator has to open several doors of the known types of vending machines to check stocks. Some known vending machines keep temperature sensitive items such as food. Opening of a door of a known type of vending machine disrupt temperature stability inside the known type of vending machine. Condensation may subsequently take place on the food after the door being shut. Water droplets mat form on the food and sometimes freezes, becoming ice. Therefore, it is the object of the current application to address the mentioned issues and provide practicable solutions.

### BRIEF DESCRIPTION OF THE DRAWINGS

The accompanying figures (FIGS.) illustrate embodiments and serve to explain principles of the disclosed embodiments. It is to be understood, however, that these figures are presented for purposes of illustration only, and not for defining limits of relevant inventions.

FIG. 1 illustrates an automatic vending store;

FIG. 2 illustrates an internal left view of the automatic vending store;

FIG. 3 illustrates a view of an ajar access door of the automatic vending store;

FIG. 4 illustrates the vending technician holding a mobile device for stocktaking;

FIG. 5 illustrates an internal right view of the automatic vending store;

FIG. 6 illustrates the modes of operation of the automatic vending store;

FIG. 7 illustrates a method of detecting an item in the automatic vending store;

FIG. 8 illustrates a method of entering the item specifications;

FIG. 9 illustrates a method of dispensing the item;

FIG. 10 illustrates a method of stocktaking with the automatic vending store;

FIG. 11 illustrates a method of arranging the item;

FIG. 12 illustrates a method of detecting ambient temperature;

FIG. 13 illustrates a method of tracking an eye of a consumer;

FIG. 14 illustrates a method of tracking a hand gesture of the consumer;

FIG. 15 illustrates a method of recognizing a voice of the consumer;

FIG. 16 illustrates a method of registering a new consumer;

FIG. 17 illustrates a method of selecting an item on the automatic vending store; and

FIG. 18 illustrates a method of requesting payment on the automatic vending store.

### DETAILED DESCRIPTION

The present application aims to provide one or more new and useful automatic vending stores. The present application further aims to provide one or more new and useful methods for making, assembling, disassembling, installing, configuring, maintaining, repairing and using the one or more automatic vending stores. Essential features of the application are provided by one or more independent claims, whilst advantageous features are presented by their dependent claims respectively.

According to a first aspect, the present application provides an automatic vending store for offering goods of sales. The automatic vending store may include one or more storage compartments for keeping the goods of sales. The one or more storage compartments may also be known as one or more shelves, cubicles, drawers or holders for storing or stacking the goods of sales. The automatic vending store may also include a payment terminal that is connected to the one or more compartments for transacting the goods of sales. The payment terminal may also be known as a point of sale terminal, a credit card terminal, EFTPOS (Electronic Funds Transfer at Point Of Sale) terminal, or a PDQ (Process Data Quickly) terminal in East Africa, which is a device for interfacing with payment cards to make electronic funds transfers. Of course, the payment terminal may also be able to handle cash transaction or payment by mobile devices, such as smartphones. The automatic vending store may further include an automatic organizer (or simply known as organizer) that may be further connected to the one or more storage compartments, the payment terminal or both for moving goods of sales, especially when no transaction takes place at the payment terminal. The automatic organizer may be able to move the goods of sales mechanically, and the automatic organizer is also known as handler, picker, fetcher, or machine assistant. For example, the automatic organizer may be able to receive, pick or hold a returned product, and transfer the returned product back to its original or a designated storage compartment (e.g. floor, box). Instead of accessing goods in a 2D (two dimensional) plane, the automatic organizer may be able to handle the goods in a 3D (three dimensional) volume, as inserting, raising lowering, pulling or even rotating a selected product according to a Cartesian coordinate system in a three-dimensional space.

The automatic vending store may provide convenience to consumers because the automatic vending store may be able to provide wide range of products twenty-four hours a day and seven days a week, which is around the clock. The automatic vending store may be able to sell goods without requiring a human operator or sales assistant so that goods of the automatic vending store may be able to be sold at lower prices, as compared to stores employing human sales assistants. Particularly, the automatic organizer may not only be able to retrieve goods from any of the storage compartments for dispensing to a customer at a dispenser, but may also be operable to move goods between the first storage compartment and the second storage compartment in the absence of sales or delivery to a customer at the dispenser. For example, the automatic organizer may be able to move goods of a partially filled first storage compartment to another partially filled storage compartment (e.g. second compartment) so that goods of the same type can be collocated inside one compartment, and an empty storage compartment may be made available to receive additional goods of sales.

Either or both of the first storage compartment and second storage compartment may include multiple slots, receptacles, boxes or cabins that are encoded with position information, capacity information or any other information (e.g. storage temperature). For example, one or more of the multiple slots, receptacles, boxes or cabins may be registered with Cartesian coordinate data (e.g. numbers of X-axis, Y-axis & Z-axis) so that the automatic organizer may be able to return or locate a predetermined storage compartment, slot, receptacle, box or cabin in order to load or retrieve goods from the predetermined storage compartment, slot, receptacle, box or cabin. Since the automatic organizer may be mechanically, electrically, pneumatically or hydraulically driven, the automatic organizer may be able to handle any goods of sales tirelessly, continuously, spontaneously or even effortlessly.

Alternatively speaking, the present application may offer an automatic vending store for offering goods of sales. The automatic vending store may include a first storage compartment and a second storage compartment for keeping the goods of sales. The automatic vending store may also include a payment terminal that is connected to the first storage compartment, the second storage compartment or both the first and second storage compartments for transacting the goods of sales automatically. The automatic vending store may additionally include an automatic organizer for moving the goods of sales between the first storage compartment and the second storage compartment. The automatic vending store may be more versatile or efficient than a conventional brick and mortar store that is operated by human store assistants.

Aspects of the application may provide an automatic organizer that includes an automatic loader for replenishing or loading the goods of sales onto the or more storage compartments (e.g. first storage compartment). The automatic loader or simply loader may be operable to capture an object (e.g. goods) from a floor and insert the object into a predetermined or designated storage compartment, shelf, cubicle, drawer or holder. In contrast to taking purchased goods to a dispenser or chute of the automatic vending store for retrieving by a customer, the loader may be configured to pick a product or object from a platform (e.g. dispenser, another storage compartment), and insert the product or object into a storage compartment (e.g. storage compartment). In fact, the loader may be able to repeat the operation so that the storage compartment can be filled, aligned or stacked with many pieces of the products or objects. Similar to the job of a human store assistant, the loader may be able to locate, recognize, pick, load or insert a chosen object or product to one or more predetermined locations.

For example, the automatic organizer or loader may be able to organize goods of a storage compartment or any sub-sections of the storage compartments (e.g. cubicle, receptacle). Particularly, the automatic organizer or loader may also be known as an automatic tallying clerk or assistant that may be able to keep a tally of quantity or weight of goods received at the automatic vending store. For example, incoming goods may be received and kept at the second storage compartment, and the automatic organizer or loader may be able to select, identify, choose or retrieve one or more predetermined goods from any sub-sections or locations at the second storage compartment, and move the one or more predetermined goods to the first storage compartment. Movement of the goods as tallying is often performed in the absence of transaction or selling so that the same automatic organizer can deliver goods of sales when having transaction, and tallying the goods in the absence of any transaction. An example of tallying the goods of sales is goods or product items management (FIFO or First In First Out) such that an empty slot on the second storage compartment may be available for receiving and temporarily storing goods from the first storage compartment. By organizing goods retrieved from the first storage compartment at an empty slot in the second storage compartment, the automatic organizer may be able to reshuffle the goods according to their expiry dates, sizes or heights so that goods of closer expiry dates may be placed in front of later expiry dates on the first storage compartment for faster selling. When necessary, the automatic organizer is operable to fetch expired goods from the first storage compartment to the second storage compartment for disposal. Of course, the first storage compartment and the second compartment are optionally collocated or integrated together as a single storage compartment or unit so that parts of the single storage compartment may be used as the first storage compartment for keeping goods, whilst some remaining or empty parts of the single storage compartment may be deployed as the second storage compartment for tallying. Exchange of functions or positions between the first storage compartment and the second storage compartment may be flexible, such as defined by computer software of the automatic vending store.

The automatic organizer can include one or more industrial robots for transferring the goods of sales (between different compartments or shelves). For example, the industrial robot may include a robot of model IRB 2600 made by ABB. The robot may optionally have one or more multiple degrees of freedom in order to retrieve the goods of sales. The robot may have an end effector or gripper that is detachable or exchangeable. In practice, the robot or industrial robot may utilize a suction cup, a force-closure, a human-hand force-closure end effector, a hoist, a conveyor belt, a vibrating feeder, a coil feeder, a hopper or a combination of any of these. Moreover, the end effector holder may have an integrator or connector that may be able to join multiple pieces or types of end effectors, whether shared or exclusively used by one or more robots. Particularly, the automatic vending store or the one or more robots may include a platform for keeping multiple pieces of end effectors, whether of the same type or sizes, or of different types of sizes. The platform may facilitate the one or more robots to release an end effector onto the platform, and install another end effector automatically. In practice, a robot having a suction cup may be able to capture a box of chocolate. The robot may be able to dislodge the suction cup at the platform and install a human-hand force-closure at the platform for retrieving a bag of frozen dumplings.

The one or more robots may be mounted on an elevated base or ground for extending their range of operation. For example, an elevated robot may be mounted onto a podium or rail 60 cm (centimeter) above a ground of the automatic vending store. Since the elevated robot occupies little floor area, the ground of the automatic vending store may be able to store goods of sales, offering extra space for keeping the goods and making the ground as another storage compartment (e.g. second storage compartment). Particularly, the elevated base or ground may optionally be 5 cm, 10 cm, 16 cm, 24 cm, 32 cm, 42 cm, 48 cm, 52 cm, 59 cm, 68 cm, 75 cm, 86 cm, 92 cm, 102 cm, 109 cm, 119 cm, 128 cm, 136 cm, 162 cm or even higher above a ground of the automatic vending store. In addition to being the rail or track for facilitating movement of the one or more robots, the elevated base or ground may be any shape or sizes, such as an elongated rectangular stand. Since a trajectory of robot radius may range from 0.45 to 1.65 metros, the elevated base or ground allows technicians to access some internal parts (known as blind spots) of the automatic vending store without the fear of being interfered or knocked by the one or more robots accidentally.

The one or more robot can include a first robot and a second robot that are configured to cooperate with each other. The one or more robots include industrial one or more robots respectively. Hence, instead of operating independently, the two robots can collaborate by fetching a heavy or fragile object together, or by exchanging a product of sales between each other. Particularly, the first robot at a first corner of the automatic vending store may be able to capture a product from the first storage compartment, and pass the product to the second robot at a second corner for loading into the second storage compartment, without travelling from the first corner to the second corner. For instance, the first robot may be ceiling mounted and the second robot may be floor mounted so that the goods at a high shelf may be able to be grabbed by the ceiling mounted robot, and received by the second robot for delivery to a dispenser or discharge chute (also known as chute) of the automatic vending store. In short, the automatic vending store can include a first holder (e.g. track or rail) and a second holder that are spread apart for anchoring the first robot and the second robot at different sides or places of the automatic vending store. One or more pieces of the track or rail may provide stable and predetermined guidance for supporting movement of the one or more robots.

The automatic vending store may optionally further include one or more cameras, either installed inside or outside the automatic vending store for recording, analyzing or inspecting operation of the automatic vending store (e.g. store replenishing, facial recognition, tallying goods). For example, the camera may be able to record a goods delivery process by a supplier. Instead of relying on report or physical observation to the goods delivery, an operator of the automatic vending store may be able to inspect or verify the goods delivery when necessary, either online or offline. One of more of the cameras are optionally shared by multiple software applications, such as by surveillance and stock taking. For instance, one or more of the cameras may be connected to a robot so that the robot becomes machine-vision enabled. As a result, the robot may be able to orientate or orient itself at the automatic vending store for capturing any goods of sales with precision in position and force. The camera enabled machine vision may further facilitate inspection of the goods of sales so that fractured or spilled goods will be spotted, cleared and cleaned.

The one or more cameras may be installed inside or outside the automatic vending store to monitor vendors, suppliers, customers, as well as the movement of the one or more robots at interior. For example, a camera mounted on an exterior wall of the automatic vending store may be able to observe purchasing behaviors of customers so that an operator of the automatic vending store may be able to analyze and optimize operation of the automatic vending store.

The automatic vending store or the one or more cameras sometimes include one or more optical character readers (OCR) for Optical character recognition, or a facial recognition for identifying a user (e.g. customer). For example, the optical character reader may be able to read and decipher an image of a personal identification card after scanning, such that the automatic vending store may be able to determine whether to sell alcoholic drinks (e.g. liquor) or cigarettes to some potential customers, after scanning their identification cards. The automatic vending store or the one or more cameras at times may include an image analyzer possibly based on machine vision possibly and/or with artificial intelligence capability. The image analyzer may be able to differentiate an imposter and an authenticate customer by rejecting fake images (e.g. large-print photo of a person). The automatic vending store or the one or more cameras by choice may include one or more barcode readers or barcode scanners, which may be capable of decoding linear bards (e.g. Code 128 according to International Standard ISO/IEC 15417) or matrix (2D) barcodes (e.g. QR code according to International Standard: ISO/IEC 18004).

The one or more storage compartments (e.g. first storage compartment) may include a storing shelf, storing compartment, storing cubicle, storing unit or storing receptacle for holding the goods of the sales and a transferring shelf (also known as storage compartment, unit, etc.) or replenish compartment for tallying the goods of sales. The transferring shelf (e.g. second storage compartment) may facilitate temporary storage or transition of the goods so that the goods can be sequentially aligned according to their expiry dates before loading into the storing shelf, the storing compartment (e.g. first storage compartment), the storing cubicle, the storing unit or the storing receptacle. Any empty places of the automatic vending store may be used as the transferring shelf (e.g. second storage compartment) so that the automatic vending store becomes compact, without having an additional shelf or storage compartment. In some cases, an empty slot or cubicle of the first storage compartment can be utilized as the transferring shelf for keeping the goods temporarily for tallying.

The one or more storage compartments (e.g. shelf, first storage compartment) may include one or more thermally insulated compartments, drawers, slots or units for keeping the goods of sales at substantially constant temperatures, which may be different from that of the ambient temperature. For example, the automatic vending store may have a heat exchanger or refrigerant compressor so that any specific thermally insulated compartment, drawer, slot or unit may be able to store the goods at predetermined temperature over a prolonged period of time. For example, a thermally insulated compartment may be kept at −5° C.˜−35° C. (minus five to minus thirty-five degrees Celsius) as a freezer; another thermally insulated compartment may be kept at 2° C.˜15° C. (two to fifteen degrees Celsius) as a refrigerator. Of course, if necessary, the thermally insulated compartment may also be capable of being kept at −40° C.˜−85° C. (minus forty to minus eighty-five degrees Celsius).

The one or more thermally insulated compartments may include an air conditioner, a refrigerator, a freezer, a chiller, a warmer or a cooker (e.g. a grill, a stove, a microwave oven), a fryer, an air fryer (e.g. by Maillard reaction). Hence, the automatic vending store may be able to store or present goods (e.g. food) with predetermined temperatures. For example, the automatic vending store may be capable of defrosting frozen food, cooking and delivering freshly cooked food to customers by the automatic organizer, offering a much wideer range of goods of sales than known convenience stores (e.g. 7-Eleven as an American-Japanese international chain of convenience stores, headquartered in Irving, Tex.).

Aspects of the one or more thermally insulated compartments may include one or more access doors respectively, which may be opened automatically for releasing the goods from the interior, or to close automatically for keeping the goods inside, coordinated with the one or more automatic organizers. For example, a thermally insulated compartment of the automatic vending store may have an automated access door at a cold storage compartment such that the automatic access door (i.e. access door) opens when the automatic organizer approaches the automatic access door for getting a frozen cod fish (Gadus) inside, and closes immediately when the automatic organizer picks the frozen cod fish and departs. Escape of cold air or intrusion of warm air may be minimized at the cold storage compartment by the access door. The automatic vending store may thus consume less energy, as well as become cheaper to operate.

The automatic vending store may additionally include one or more moisture absorbers, dehumidifiers, water vapour removers or store dryers for removing water vapour, mist or water inside the automatic vending store. Since water often causes deterioration of performance to equipment at the automatic vending store, the one or more moisture absorbers, dehumidifiers, water vapour removers or store dryers enables excellent performance of the equipment at the automatic vending store. Moreover, dry interior of the automatic vending store prevents growth of fungi or bacteria at the automatic vending store, extending shelf life of the goods of sales.

The one or more storage compartments, shelves or thermally insulated compartments of the automatic vending store can be partially or substantially sealed or closed. For example, the automatic vending store may have one or more wine racks or wine storage cabinets that protect alcoholic beverages of the automatic vending store from potentially harmful external influences, providing darkness, constant temperature, and constant humidity, similar to wine cellars. Sealing of any of the compartments is possibly achieved by windows, doors or panels, whether with gasket or O-rings, sometimes providing hermetic or waterproof sealing.

The automatic vending store may further include one or more user interfaces connected to the payment terminal, the automatic organizer or both for operating the automatic vending store. The user interface may also be known as a user terminal so that a user (e.g. customer or service technician of the automatic vending store) may be able to operate (e.g. transact or diagnose) with the automatic vending store. Besides, the automatic vending store may have multiple user interfaces or terminals so that several users are able to operate the automatic vending store simultaneously, without interfering each other. For example, two customers may be provided with separate touchscreens for purchasing their goods, whilst a service technician may be able to upload software patch at another user interface or terminal in the meantime. Instead of employing many human sales assistants, the automatic vending store may be capable of interacting with and serving quite a few customers without delaying any of them.

The one or more user interfaces or terminals may include a first user interface (e.g. touchscreen) and a second user interface (e.g. speech recognition device) that are spaced apart or at different positions (e.g. height). For example, the first user interface may include a microphone at 90 cm off the ground so that a child may be able to speak to the automatic vending store for buying candies. The second user interface may have a touchscreen that gives a graphic user interface at 1.2 m (meter) above the ground so that a disabled customer in a wheelchair may be able to purchase goods with the automatic vending store easily. Also, the automatic vending store may optionally include two user terminals or interfaces that are laterally spaced apart (e.g. 20 cm, 30 cm, 50 cm, 75 cm, 100 cm or 125 cm apart, etc.) so that two customers can stand next to each other when transacting with the automatic vending store.

The first user interface and the second user interface can include chutes or dispensers respectively, which may be spaced apart for delivering the goods of sales to users separately. Multiple users or customers may be able to fetch or obtain their purchased goods at different locations of the automatic vending store, offering convenience, privacy and comfort of large space.

The user interface may include a gesture recognizer, a speech recognizer, a facial recognizer, haptic device, a touchscreen, a LCD/LED/plasma screen. Customers of different profiles (e.g. abled people or mute user) or preferences may be able to transact with the automatic vending store with confidence and convenience, assisted by the diverse types of user interface or terminal. For example, a touchscreen of the user interface includes a monitor filter (e.g. a screen protector, privacy screen, an anti-glare filter) for protecting the touchscreen so that a touchscreen of the user interface enjoys prolonged life span.

The automatic vending store may further include a communication unit (e.g. network interfaces, network interface controller) for communicating with an electronic communication device. The communication unit may optionally connect to any of the storage compartments, the payment terminal or the automatic organizer. The communication unit may be able to transmit the data by cable(s) or wirelessly. For example, the communication unit can communicate with other electronic devices wirelessly by radio waves, sound waves or infrared light. Optionally, the communication unit includes one or more modems (modulator-demodulators) that may be able to transmit and/or receive electronic signals of 2G (second-generation wireless telephone technology), 3G (third generation of wireless mobile telecommunications technology), 4G (fourth generation of mobile telecommunications technology), LTE Advanced Pro (LTE-A Pro, also known as 4.5G, 4.5G Pro, 4.9G, Pre-5G, 5G Project, and so on), 5G (5th generation mobile networks or 5th generation wireless systems) or more advanced generations. The communication unit can have one or more antennas that facilitate other types of wireless communication, such as Bluetooth (using short-wavelength UFIF radio waves in the ISM band from 2.4 to 2.485 GFIz), Zigbee (IEEE 802.15.4-based specification). The communication unit may include a wired communication unit (e.g. ADSL modem) so that existing infrastructure (e.g. telephone network) may be readily utilized. The communication unit facilitates remote diagnosis, observation, and real time monitoring to the of the automatic vending store.

If adopting the wireless data transmission, the communication unit may be configured to communicate (e.g. broadcast) with a mobile electronic device of a user automatically, according to identification of the user, possibly obtained by the one or more biometric readers. For example, the communication unit may be able to transmit text messages (e.g. Short Message Service), images (e.g. promotion voucher) or alert signals (e.g. ringing tones or beeps) to the mobile electronic device (e.g. smartphone) if detecting close presence of the user.

The communication unit can additionally include an encrypter (i.e. encrypting device) or encoder that deploys cryptography to protect the data transferring. In one instance, the communication unit may employ a pseudo-random encryption key generated by an algorithm so that only an authorized recipient can decrypt the data with a suitable key provided by an originator to recipients, but not to unauthorized users or interceptors. The communication unit can also include a buffer or data buffer for storing data temporarily when operating the automatic payment terminal, the biometric reader or both.

The automatic vending store or the communication unit may include one or more electronic identities, or a single unique electronic identify for identifying the automatic vending store, the payment terminal or both the automatic vending store and the payment terminal (i.e. automatic payment terminal). The electronic identify may also be known as an identification number (e.g. serial number, identifier) or an electronic identification number that provides identity or a unique name of the automatic vending store or the communication unit, which may be automatically accessed or read by other electronic devices (e.g. computer, barcode reader). The identification number or electronic identification number can be associated with characteristics of the automatic vending store or its goods (i.e. products) so that an operator of the automatic vending store may be able to monitor operation of the vending closely, replenishing goods or repairing components upon receiving request from the automatic vending store, whether manually or automatically. For example, the identification of the automatic vending store may be linked to a geographical location of the automatic vending store so that the operator can provide precise location of the automatic vending store to a supplier for refilling the automatic vending store timely.

The identification of the automatic vending store or the communication unit may offer a unique identifier or unique electronic identifier for automatic vending store or the communication unit of the automatic vending store. The unique identifier may include a barcode, a serial number, a machine readable code, a QR (Quick Response) code, an IP (Internet Protocol) address (e.g. IPv4 address, IPv6 address), a MAC (Media Access Control) address, an IMEI (International Mobile Equipment Identity) number, a Wi-Fi address, a digital identity, an electronic address by hardware (e.g. screw position of a terminal block) or software (e.g. digital address “01”, “11”). The electronic address in the software form may include digital addresses that are possibly recorded or programmed in a memory of the automatic vending store or the communication unit. The automatic vending store can further be locked or unlocked remotely for receiving goods replenishing or disposing expired goods. One or more electronic addresses may be used as the identity or electronic identity of the automatic vending store.

The automatic vending store can further include a recorder, a tracker or stock taker for recording stock or transactions of the goods on the shelf. For example, the recorder may include a scanner on a chute of the automatic vending store. The scanner may be connected to a computer of the automatic vending store so that every outgoing good may be scanned and recorded by the computer, which may keep records of goods sold as existing the chute linking to a product dispenser (also known as take-out port) of the automatic vending store. The recorder, tracker or stock taker can be implemented by hardware components, software programs or both, whether connected to a local computer or a remote computing server. Of course, the recorder, tracker or stock taker can take stock of incoming goods, outgoing goods or both so that the automatic vending store has an updated records of available goods, possible to send request of goods replenishment when necessary.

The communication unit may include one or more computer ports, whether by hardware or software for computer networking. The computer ports may facilitate secure, fast and stable communication so that the automatic vending store may be inspected or monitored remotely.

The automatic vending store may additionally include one or more hub connectors for bundling some signal wires, some power cables or both the signal wires and power cables together. The hub connector can adopt a quick connect mechanism (e.g. snap & lock) or foolproof coupling so that the automatic vending store may be easily transported to a different site, and quickly connect to a single or a few docking ports for fast operation. Technicians or operators of the automatic vending store do not have to identify and connect every signal or power lines individually.

The automatic vending store may further include a casing, a housing or a cover that conceals some components of the automatic vending store against external intrusion, whether by rain, dust or robbery. For example, the casing may have legs that keep the automatic vending store off the ground, preventing rainwater from flooding the goods of sale inside the automatic vending store. The casing, the housing or the cover may optionally have ventilation holes, slits or lattices so that interior air of the automatic vending machine is kept fresh. One or more air filters and/or ventilation fans may be further installed at the automatic vending store for keeping the interior of the automatic vending store clean and hygienic, whether on the casing or not.

The automatic vending store can include an automatic alarm or simply alarm that is configured to send audio, electronic or visual signals to an operator in case of intrusion, as unauthorized access or irregular operation. The alarm may be able to alert operators or police when facing burglary. Of course, the camera or surveillance camera can automatically capture images (e.g. photos or videos) of intruders, as activated by the alarm.

The automatic vending store may further include a local energy source (e.g. renewable energy harvester, battery) for powering the automatic vending store. The renewable energy harvester may be able to glean or store solar power, thermal energy, wind energy, salinity gradients, and kinetic energy for operating the automatic vending store. The local energy source may also include a battery or power generator that may be able to sustain automatic vending store over a predetermined period of time. When facing low power reservation or availability, the automatic vending store may be able to send alarm or message to its operator for rescue, and shut down some non-essential functions of the automatic vending store, known as hibernation.

The automatic vending store may optionally include an energy saver for adjusting power consumption of the automatic vending store in response to purchasing activities of the automatic vending store. The energy saver can be in software or hardware form, which may be connected to the local energy source. The energy saver may preserve or reduce energy consumption at the automatic vending store.

The automatic vending store may have a modular structure so that multiple pieces of the automatic vending stores are able to be joined together, providing a larger shopfront. The modular structure may include connectors, locks and bridge joints for joining two or more automatic vending stores mechanically, electrically and/or electronically.

In some cases, the automatic vending store or the one or more storage compartments may have a height of 1.8 m (meters), 2.3 m, 2.5 m, 2.8 m, 3.2 m, 3.6 m or higher. In other words, the automatic vending store has one or more tall storage compartments for storing goods, which may be neither visible nor accessible directly by its customers. A tall automatic vending store may utilize vertical space for keeping more goods, and may be able to fetch chosen goods by the automatic organizer. Alternatively, the tall automatic vending store requires less floor area or footprint for keeping the same amount of goods, as compared to the known convenience stores.

Possibly, the automatic vending store further includes one or more windows for exposing or delivering the goods to a customer by the automatic organizer. Instead of viewing or inspecting the goods from a display screen or a window, the automatic organizer may be able to bring a chosen product to a customer or receive a returned product from a customer. The window may optionally be sealed or covered by a transparent material (e.g. glass), whether partially or fully.

The automatic vending store may further include one or more transparent, opaque or semitransparent panels for covering, shielding, blinding or exposing the goods of sales, whether on the casing or window. The one or more panels may optionally include one or more display screens (e.g. touchscreens) for interaction with customers or users.

The automatic vending store may include one or more timers or clocks that facilitate time restriction for sales of controlled items (e.g. cigarettes and liquor), which are not available after permitted time slots according to laws or regulations. For example, the automatic vending store may be configured or operable to refuse selling of vodka after 10 PM (22:00) daily. A computer, which may optionally include the communication unit, the clock, the timer and/or other components, can be remotely configured or operated to make necessary changes (e.g. software patching).

The automatic vending store or its component (e.g. computer) may be installed with a customer relationship management (CRM) programme, which may be configured to manage interaction between the automatic vending machine and its customers. The customer relationship management uses data analysis about customers' history with the automatic vending machine to improve business relationships with customers, specifically focusing on customer retention and ultimately driving sales growth. Alternatively speaking, the customer relationship management (CRM) programme may be able to track, record, recognize, analyze, transmit and/or store consumers' behavior information for improved consumer shopping experience.

The automatic vending store can update inventory of the automatic vending store, such as by setting up inventory buffer level, sending out order notification when encountering low buffer at the automatic vending store. In other words, the automatic vending store may be able to send messages or alarms to a remote computing server or a mobile device so that an operator or supplier of the vending machine may be able to replenish the goods of sales to the automatic vending machine.

According to a second aspect, the present application may provide a method of using an automatic vending store. The method may include a first step of providing an automatic vending store; a second step of loading a first storage compartment of the automatic vending store with goods of sales; and a third step of moving one or more of the goods of sales from the first storage compartment to a second storage compartment of the automatic vending store automatically, in the absence of transaction. Hence, the automatic organizer may be able to sort or arrange the goods of sales inside the automatic vending store, instead of just pushing out an item of the goods of sales when receiving payment. The automatic organizer sometimes performs tasks of a tallying clerk. Hence, the moving of the one or more of the goods of sales may optionally include a step of tallying the goods of sales.

The method can further include a step of examining identifying information of a user (e.g. customer or service technician); and another step of deciding on whether to grant access to the user. For example, the automatic vending machine may be able to scan, recognize (e.g. by OCR and decide on whether the user is allowable to transact or access the automatic vending store. For example, the automatic vending store may be able to scan a face of a service technician and verify with a remote database on whether the service technician is permitted to open the automatic vending store.

The method may further include a step of sending message to a remote electronic device for replenishing the goods of sales. The communication unit of the automatic vending store may be able to transmit electronic data or message remotely in order to keep stock of the automatic vending machine at a sufficient level.

The method may include a step of transferring an item or product (as goods of sales) between a first automatic organizer and a second automatic organizer of the automatic vending machine. The two automatic organizers may be able to cooperate with each other or work independently from each other so that the automatic vending store may be able to handle a larger area or wider range of goods of sales.

According to a third aspect, the present application provides a method of detecting the availability of one or more pieces of goods of sales. The method includes a first step of identifying a disruption of signal of one or more sensors; a second step of identifying a location of the disruption; a third step of checking an allowable item in the location; and fourth step of recording the number of items in the location.

According to a fourth aspect, the present application provides a method of entering an item specification for one or more goods of sales. The method includes a first step of encoding the item specifications in a machine and human readable file (XML); and a second of saving the machine and human readable file into a memory storage (USB, local computer, remote computer).

According to a fifth aspect, the present application provides a method of dispensing goods of sales. The method includes a first step of receiving a selection of an item of the goods of sales from a tactile display screen; a second step of activating an automatic organizer (e.g. robotic arm); a third step of picking the item; a fourth step of detecting a disruption of signal of the sensor in the location to adjust the quantity (e.g. decrease); and a fifth step of depositing the item into a dispensing chute or dispenser.

According to a sixth aspect, the application offers a method of stocktaking. The method includes a first step of locating the position of a mobile device (e.g. smart phone of the vending technician); a second step of loading the relevant machine and human readable file into the mobile device; a third step of scanning a machine readable code (UPC) on the item; a fourth step of placing the item in the location determined by the machine and human readable file; and fifth step of checking the number of disrupted sensors (e.g. counting by computer).

According to a seventh aspect, the application provides a method of arranging the item, which includes a first step of picking and placing the old items from a first location to a temporary storage; a second step of picking and placing the new items from a second location into the first location; a third step of picking and placing the old items from the temporary storage to the first location.

According to an eighth aspect, the present application offers a method of tracking at least one (i.e. one or more) eye of a consumer using a camera. The method includes a first step of tracking a face; a second step of tracking a location of the eyes; a third step of detecting the presence of a sclera and an iris; and a fourth step of effecting a selection by blinking.

According to a ninth aspect, the present application provides a method of tracking a body gesture (e.g. hand movement) of a consumer using the camera. The method includes a first step of tracking the face; and a second step of tracking a hand and the digits.

According to a tenth aspect, the present application provides a method of recognizing and interpreting a voice using a microphone. The method includes a first step of identifying the harmonics of the voice of the consumer; a second step of matching the harmonics with the saved harmonics in the memory storage; and a third step of interpreting the harmonics to a corresponding command.

According to an eleventh aspect, the present application provides a method of registering a new member. The method includes a first step of receiving a tactile input or an eye input or a voice input or all or combinations thereof; a second step of capturing an image of a face of the consumer (e.g. authentication, facial payment); and a third step of acquiring a voice recording (authentication) of the consumer.

According to a twelfth aspect, the application presents a method of payment that includes a first step of presenting a plurality of payment options such as cash, card, contactless (e.g. by NFC, smartphone) or facial scanning; and a second step of deducting an equivalent value from the account of the consumer.

According to a thirteenth aspect of the application, the present application provides a method of controlling the sales of items by time. According to a thirteenth aspect of the application, the applications offers a method of controlling the sales of items by facial recognition, wherein a saved registered image is compared with a live image of the consumer. Some of the previously mentioned methods or method steps are able to be combined, divided or changed in sequence.

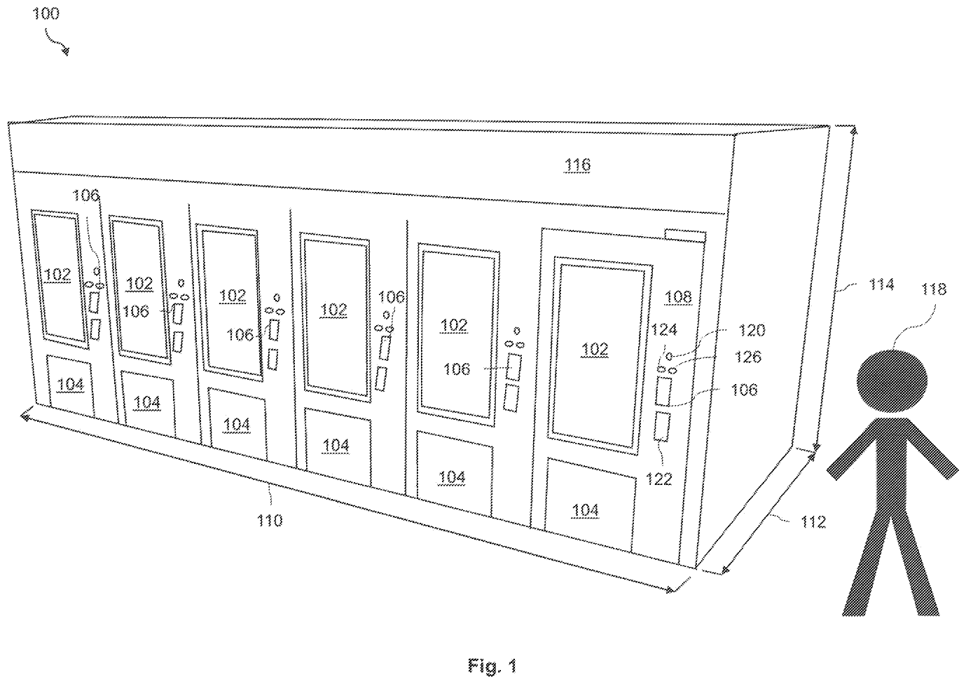

Exemplary, non-limiting Aspects of the present application will now be described with references to the above-mentioned figures. Particularly, FIGS. 1 to 5 refer to a first Aspect of the present application.

FIG. 1 illustrates an automatic vending store 100 with six display screens 102 positioned at a front side 101 thereof and six dispensers 104 positioned below the display screens 102. There may be also six payment terminals 106 located on the right sides of the display screens 102. Below the payment terminal 106 may be a reader module 122. Above the payment terminal 106 may be a vending external camera 120, a microphone 124 and a speaker 126.

On a right front side of the automatic vending store 100 may be an access door 108. A height of the access door 108 may be about two thousand millimetres (2000 mm) with a breadth of about eight hundred millimetres (800 mm) and a thickness of about three hundred millimetres (300 mm). A vending technician 118 may stand on a right side of the automatic vending store 100.

The automatic vending store 100 may have a store length 110 of about five thousand millimetres (5000 mm), a store depth 112 of about two thousand millimetres (2000 mm) and a store height 114 of about two thousand eight hundred millimetres (2800 mm). At a top store length 110 of the automatic vending store 100 is a stretch of static advertisement section 116.

The height of the one tactile display screen 102 is about one thousand millimeters (1000 mm) and a width of about five hundred millimetres (500 mm or millimeters).

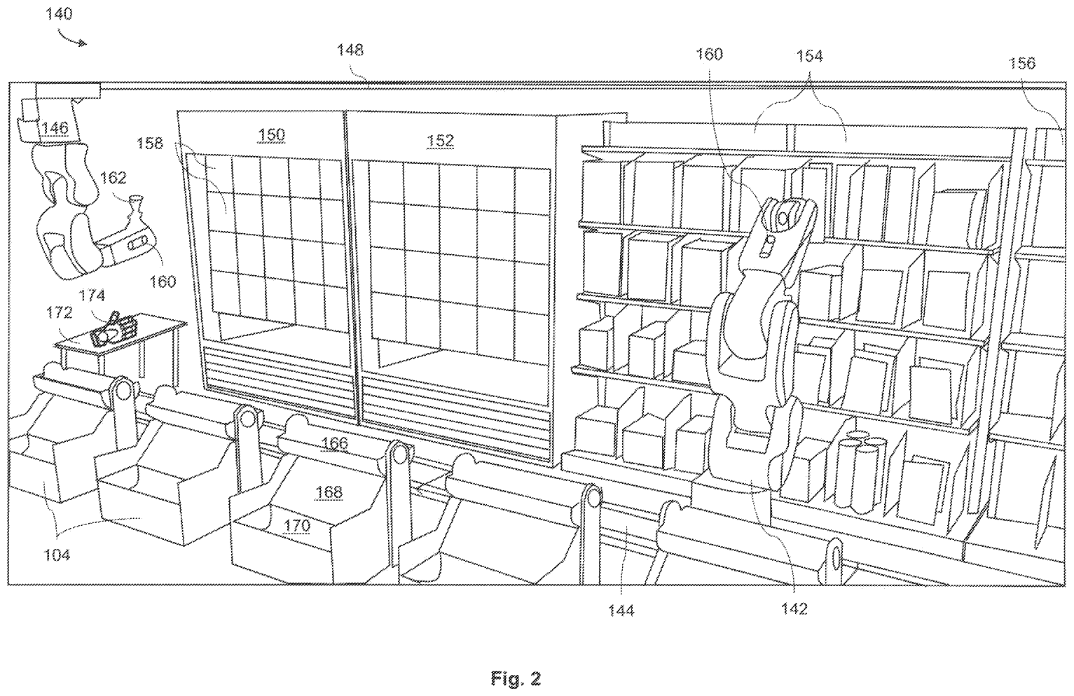

FIG. 2 illustrates an internal left view 140 of the automatic vending store 100. The front side of the automatic vending store 100 may be removed exposing the five dispensers 104 on a ground arranged in a straight line. Each dispenser 104 may include a pivotal trough 166 that is pivotally supported by two stands on the sides. Below the pivotal trough 166 may be an inclined plane 168 that leads to a collection trough 170 at a bottom near the ground.

Behind the dispensers 104 may be a lower anthropomorphic robotic arm 142 with an end effector at its terminal. The lower anthropomorphic robotic arm 142 may travel along a lower rail track 144 which is laid on the ground. The lower anthropomorphic robotic arm 142 may be slightly elevated at about six hundred millimeters (600 mm). The lower anthropomorphic robotic arm 142 may be mounted on a stepper motor (not shown) with an enclosure that is responsible for lateral movement on the lower rail track 144. The upper anthropomorphic robotic arm 146 may also be mounted on another stepper motor (not shown).

The lower rail track 144 may extend the whole store length 110 of the automatic vending store 1 00. The lower rail track 144 may be made up of more than one short lower rail track 144. Directly above the lower anthropomorphic robotic arm 142 may be an upper anthropomorphic robotic arm 146 which may travel along an upper rail track 148. Similarly, the upper rail track 148 may be made up of more than one short upper rail track 148. The upper rail track 148 may be installed on the top internal side of the automatic vending store 100. Both the lower and upper anthropomorphic robotic arm 142,146 may have at least one robot camera 160 attached near an at least one end effector 162. The end effector 162 may include either a suction cup or a grasping digits 174. The robot camera 160 may be connected to a local computer 164 either through electrical wires or wirelessly. The local computer 164 may be hidden from sight to the vending technician 118. At the left end of the lower rail track 144 may be a table 172. On the table 172 top is the grasping digits 174.

Behind the rail tracks 144,148 may be four different storage sections. The storage section may include the freezer 150, the chiller 152, the ambient storage 154 and the inventory storage 156. Starting from the left side as viewed from the front side of the automatic vending store 100 may be a freezer 150, a chiller 152, an ambient storage 154 and an inventory storage 156. The freezer 150 and the chiller 152 may have a plurality of automatic doors 158 located at the front side thereof. There may be five columns by four rows of individual storage compartments in each of the freezer 150 and the chiller 152. The automatic doors 158 may be positioned in front of each storage compartment. The automatic doors 158 may be controlled by the local computer 164. There may be two ambient storages 154 as shown in FIG. 2. The first ambient storage 154 may have four shelves and four columns separated by a vertical divider. The second ambient storage 154 may have four shelves and three columns. The first ambient storage 154 stores may include regular shaped items such as boxed items which have flat surfaces. The second ambient storage 154 stores may include irregular shaped items such as tubes and vertical form fill and seal (VFFS) pillow bags. The inventory storage 156 may be on the right side of the second ambient storage 154 which is vacant.

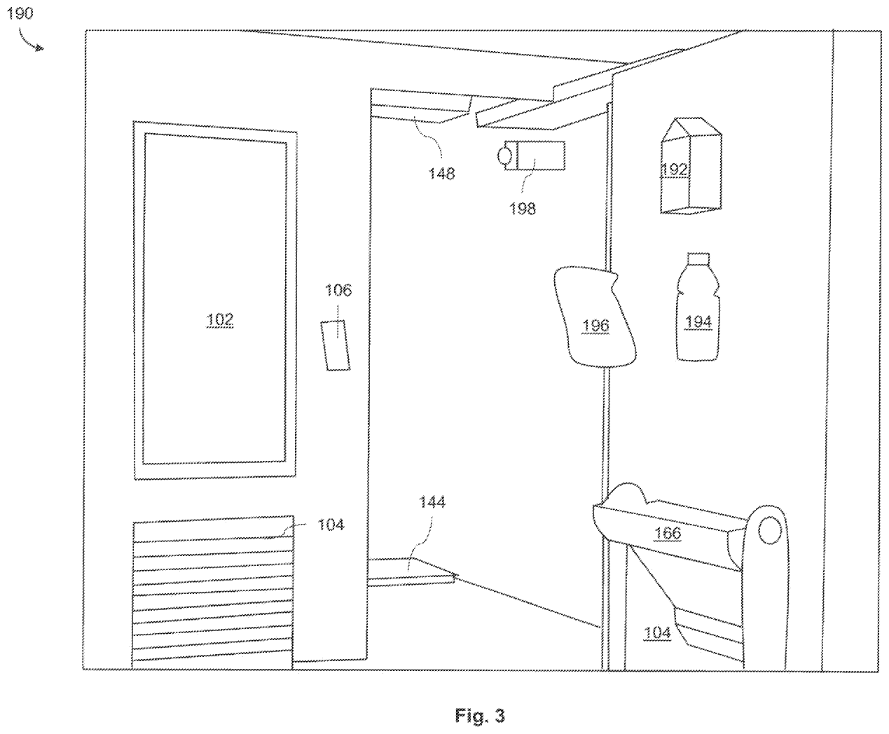

FIG. 3 illustrates a view 190 of an ajar access door 108. Three different items may be deposited at the inventory storage 156 inside the automatic vending store 100. The regular shaped item is item with the flat surface is the tetra pack 192. The irregular shaped items are a bottle 194 and a pillow bag 196. A vending camera 198 may be installed inside at a high position near the access door 108 overseeing the entire internal automatic vending store 100.

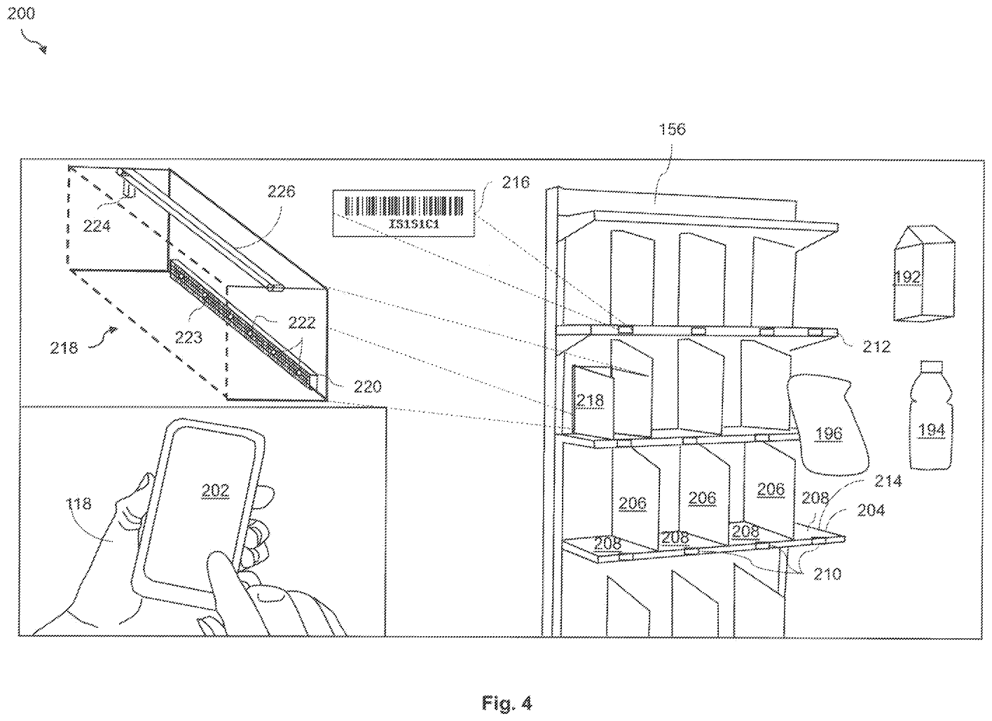

FIG. 4 illustrates the vending technician 118 holding a mobile device 202 for stocktaking 200. The tetra pack 192, the bottle 194 and the pillow bag 196 may be placed onto the inventory storage 156 by the vending technician 118. The inventory storage 156 may have four horizontal shelves 204. Each shelf 204 may be separated by three vertical shelf dividers 206 to demarcate four compartments 208. In each compartment 208, a label 210 may be adhered to a surface of the shelf 204. The surface of the shelf 204 may be specifically at a front surface 212 of the shelf 204 which may be visible to a standing vending technician 118. The exception may be a bottom shelf (not shown) where the surface of the shelf 204 refers to a top surface 214. The four compartments 208 on the one shelf may have four labels 210 thereon. Alternatively, the label 210 can be adhered to the two surfaces namely the front surface 212 and the top surface 214.

The label 210 on the four shelves 204 of the inventory storage 156 may be a machine-readable code, for example, a barcode 216. The barcode 216 may be a linear or one dimensional represented by widths and gaps of parallel lines usually vertical lines. The barcode 216 may be compliant with the international barcode quality specification ISO/IEC 15416 (linear).

The top shelf also known as the first shelf is labelled as S1. The shelf below the top shelf, S1 may be known as the second shelf is labelled as S2. Below the second shelf, S2 is the third shelf labelled as S3. The bottom shelf may be known as the fourth shelf and labelled as S4.

Each compartment on each shelf is also labelled starting from the left progressing to the right is C1, C2, C3 and C4 which means compartment 1, compartment 2, compartment 3 and compartment 4 respectively.

Therefore, to differentiate the different compartments on different storage sections, a unique identifier may be assigned to each compartment. For example, “IS1 S1 C1” represents the inventory storage 1 (IS1), the first shelf (S1), the first compartment (C1). Other storage sections; the freezer 150, the chiller 152 and the ambient storage 154 are also assigned a code.

The unique identifier may be coded onto the barcode 216 specifically using Code-128 which is a high density linear barcode 216 symbology. It is used for alphanumeric or numeric-only barcodes. It can encode all one hundred and twenty-eight characters of ASCII and, by use of an extension (FNC4), the Latin-1 characters defined in ISO/IEC 8859-1. Code 128 includes one hundred and eight symbols: one hundred and three data symbols, three start symbols, and two stop symbols. Each symbol consists of three black bars and three white spaces of varying widths. All widths may be multiples of a basic “module”. Each bar and space may be one to four modules wide, and the symbols may have a fixed width: the sum of the widths of the three black bars and three white bars may be 11 modules.

The stop pattern composes two overlapped symbols and has four bars. The stop pattern permits bidirectional scanning. When the stop pattern is read left-to-right (the usual case), the stop symbol (followed by a 2-module bar) is recognized. When the stop pattern is read right-to-left, the reverse stop symbol (followed by a 2-module bar) is recognized. A scanner seeing the reverse stop symbol then knows it must skip the 2-module bar and read the rest of the barcode 216 in reverse.

Code-128 does not have one hundred and twenty-eight distinct symbols, so it cannot represent one hundred and twenty-eight code points directly. To represent all one hundred and twenty-eight ASCII values, it shifts among three code sets (A, B, C). Together, code sets A and B cover all one hundred and twenty-eight ASCII characters. Code set C is used to efficiently encode digit strings. The initial subset is selected by using the appropriate start symbol. Within each code set, some of the one hundred and three data code points are reserved for shifting to one of the other two code sets. The shifts are done using code points ninety-eight and nighty-nine in code sets A and B, one hundred in code sets A and C and one hundred and one in code sets B and C to switch between them):

128A (Code Set A)—ASCII characters 00 to 95 (0-9, A-Z and control codes), special characters, and FNC 1-4;

128B (Code Set B)—ASCII characters 32 to 127 (0-9, A-Z, a-z), special characters, and FNC 1-4;

128C (Code Set C)—00-99 (encodes two digits with a single code point) and FNC1.

The barcode 216 for the inventory storage 1 (IS1), the first shelf (S1), the first compartment (C1) is as shown in FIG. 4 using the Code 128B (Code Set B).

Besides the labels 210 on the individual compartments 208 of the shelves 204, the items may also be labelled. The items refer to the tetra pack 192, the bottle 194 and the pillow bag 196. An example of the tetra pack 192 is a packet of milk. An example of the bottle 194 is a bottle of fruit juice and an example of the pillow bag 196 is a packet of potato chips.

The items 192,194,196 use Universal Product Code (UPC). The UPC is a barcode symbology (technically refers to UPC-A) consists of 12 numeric digits, that are uniquely assigned to each trade item. Along with the related EAN (European Article Number) barcode, the UPC is the barcode mainly used for scanning of trade items at the point of sale (POS), per GS1 (GS1 is a not-for-profit organisation that develops and maintains global standards for business communication) specifications. In addition to the POS, the UPC is also used for inventory tracking.

UPC data structures are a component of GTINs (Global Trade Item Number) and follow the global GS1 specification, which is based on international standards. But some retailers (clothing, furniture) do not use the GS1 system (rather other barcode symbologies or article number systems). On the other hand, some retailers use the EAN/UPC barcode symbology, but without using a GTIN (for products, brands, sold at such retailers only).

The mobile device 202 held by the left hand of the vending technician 118 has a software application in it. An index finger of a right hand of the vending machine 118 is guided by the instructions on a display screen of the mobile device 202. The mobile device 202 can be a smartphone or a tablet with wireless communication capability.

Alternatively, the individual compartment 208 can have a detachable tray installed which is shown in FIG. 4 located at the inventory storage 156, second shelf, first compartment (IS1 S2C1). The detachable tray 218 may be a closed rectangular metal box with an opened side. The opened side is facing away from the shelf 204. Inside a right bottom corner is a strip of breadboard 220. The breadboard 220 may be placed longitudinally along a length of the detachable tray 218. At an end of the breadboard 220 may be a coupler (not shown) that may be connected to another coupler for electricity and signal transfer between at least one photoelectric sensor 222 and the local computer 164. The breadboard 220 may have a plurality of perforations on its surface providing the insertion of the at least one photoelectric sensor 222 through the perforations. There are six photoelectric sensors 222 on the strip of breadboard 220. At the top side disposed towards the centre of the detachable tray 218 is a tray camera 224 mounted on a conveyor belt 226.

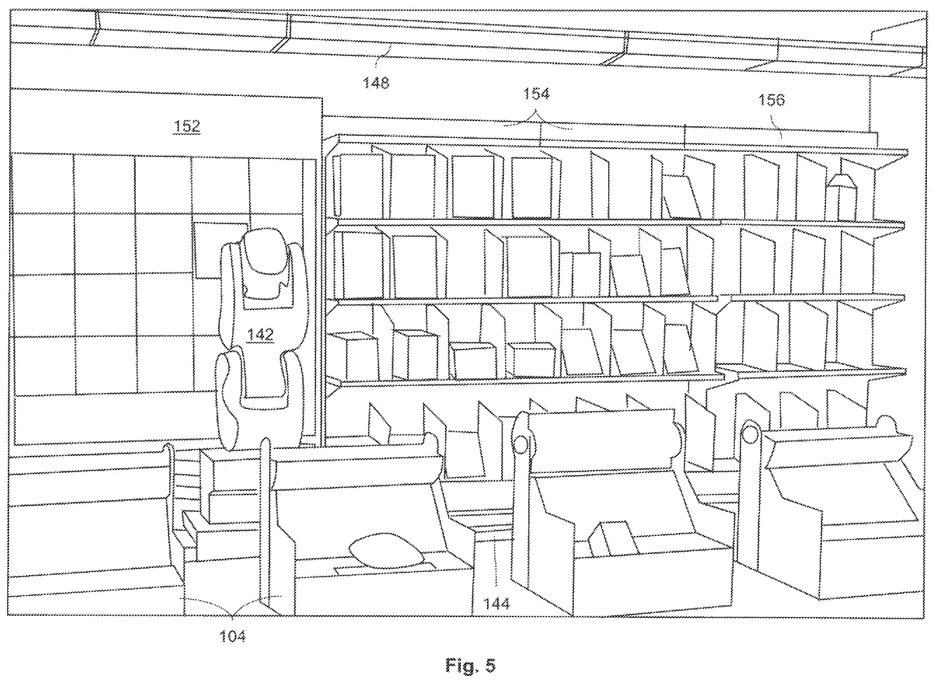

FIG. 5 illustrates an internal right view of the automatic vending store 100 with the upper rail track 148 located above and in front of the storage sections. A view of the inventory storage 156 is shown with a tetra pack 192 at the first shelf 204, third compartment 208 which is labelled with a barcode of IS1 S1 C3.

The second ambient storage 154 may be located at the left side adjacent to the inventory storage 156 as seen from the front. The first ambient storage 154 may be located at the left side adjacent to the second ambient storage 154 as seen from the front.

The second ambient storage 154 may have four shelves 204 and on each shelf has three compartments 208. Each compartment is labelled with barcodes bearing a unique identifier. On the first shelf, compartment one, AS2S1 C1 and two, AS2S1 C2 are filled with cylindrical containers of potato chips. Still on the first shelf, compartment three, AS2S1 C3 is filled with pillow bags of potato chips. Moving on to the second shelf, compartment one, AS2S2C1 is filled with boxes of muesli. Compartment two and three, AS2S2C2 and AS2S2C3 are filled with pillow bags of corn chips. Moving on to the third shelf, compartment one, two and three, AS2S3C1, AS2S3C2 and AS2S3C3 are filled with pillow bags of various items.

The first ambient storage 154 may have four shelves and on each shelf four compartments. On the first shelf, all four compartments, AS1 S1 C1, AS1 S1 C2, AS1 S1 C3 and AS1 S1 C4 are filled with boxes of cereals. Similarly, for the second shelf, all four compartments, AS1 S2C1, AS1 S2C2, AS1 S2C3 and AS1 S2C4 are filled with boxes of cereals. The same goes for the third and the fourth shelf with all four compartments, AS1 S3C1, AS1 S3C2, AS1 S3C3, AS1 S3C4, AS1 S4C1, AS1 S4C2, AS1 S4C3 and AS1 S4C4.

The chiller 152 may have four rows and five columns of compartments. Each compartment is also labelled, for example, C1 S1 C1 represents Chiller 1, Shelf 1, Compartment 1 and C1 S4C5 represents Chiller 1, Shelf 4, Compartment 5. Compartment 1 begins on the left and Compartment 5 ends on the right. Shelf 1 begins on the top shelf and Shelf 4 on the bottom shelf.

The lower anthropomorphic robotic arm 142 is shown picking a chilled item from the chiller 152, specifically C1 S3C4 or Chiller 1, Shelf 3, Compartment 4. There are items deposited in the dispensers 104.

Functionally, the access door 108 at the front side of the automatic vending store 100 provides a walk-in access into the automatic vending store 100 by the vending technician 118. The automatic vending store 100 as shown in FIG. 1 is installed at a built-up area where the sides thereof are attached to fixed installation such as a wall (not shown). The provided dimensions of the access door 108 may provide convenient access to the vending technician 118 who may carry items for replenishment as well as retrieval of defective or soon-to-be expire items from the automatic vending store 100.

The vending external camera 120 may provide an image and video capturing means. In particular, the face of the consumer during registration and facial detection and recognition. In addition, the acquired image of the consumer may provide image identification. For example, if a registered member of the automatic vending store 100 was a twenty-year-old man with a registered image in the local computer 164. An impostor who may be a sixteen-year-old girl wanted to buy a controlled item (cigarette or alcohol) using the twenty-year-old man identity, the vending external camera 120 may be able to recognize the impostor and forbid further transaction. The algorithm in the local computer 164 may even alert the registered member and the law enforcement authority.

The reader module 122 provides a means to read the information of a smartcard and a smart phone having NFC (Near Field Communications) protocol of the consumer specifically for payment. The microphone 124 may provide a voice acquiring means for translating the voice into a tangible action of the automatic vending store 100. The speaker 126 may provide an output audible sound which can be a pre-recorded set of messages for certain actions or an audible alarm or both. For example, if there were no stocks left for an item and the consumer continued to select, an audible message would be heard like “Sorry the item you've selected is not available.” The message may also be displayed on the tactile display screen 102 to inform the consumer.

The static advertisement section 116 may be located at the top store length as the advertisement is not frequently changed. It may also provide a channel for advertisers to communicate their brands to the consumers who visit the automatic vending store 100. The static advertisement section 116 may be a source of revenue generating medium for the owner of the automatic vending store 100.

In the event if there were no advertiser, the brand name of the automatic vending store 100 can be placed. The advertisement section 116 may be a light box which has a translucent Perspex at a front with fluorescent tubes or LED (light emitting diodes) or neon lights spread evenly inside the light box to provide uniform backlit illumination.

The dispenser 104 may typically be positioned lower as it is considered infrequent access compared to the tactile display screen 102 which is accessed frequently and at a height that is convenient to see at a standing position. Normally the consumer has to look at the items on offer at the automated vending store 100 before committing to purchase at least one item. Very often the consumer may not even purchase anything. Hence, it is of ergonomics and practical reason that the dispenser 104 is positioned lower.

The pivotal trough 166 may provide a holder for a purchased item. The purchased item is deposited at the pivotal trough 166 by either the lower anthropomorphic robotic arm 142 or the upper anthropomorphic robotic arm 146. The local computer 164 may control the turning of the pivotal trough 166. Once tilted in an anti-clockwise direction as observed from the right side, the purchased item drops and slides on the inclined plane 168 and slides into the pivotal trough 170 for collection. The pivotal trough 166 and the collection through 170 are formed in a half cylindrical shape so that the purchased item will not be damaged. Especially for item with rounded surface such as glass or bottle, the item can rest safely within the trough 166,170.

Between the storage sections at the rear and the dispensers 104 at the front, the lower rail track 144 may be laid on the ground to provide a linear track for lateral movement (right to left and left to right) for the lower anthropomorphic robotic arm 142. The lower anthropomorphic robotic arm 142 may be slightly elevated so that more storage space is available on the ground which is not occupied by the lower rail track 144. Conversely, if the lower anthropomorphic robotic arm 142 is not elevated, the rotation on its own axis will render no storage space as the space is needed for its maneuverability especially when picking item from the storage sections, rotating and depositing at the pivotal trough 166.

The lower and upper anthropomorphic robotic arm 142,146 provides the picking of item from one storage section to another storage section or to the dispenser 104. The lower anthropomorphic robotic arm 142 may serve the lower height shelves. The upper anthropomorphic robotic arm 146 may serve the higher shelves. The lower and upper anthropomorphic robotic arm 142,146 is a ABB® IRB 2600 IRC5 which has a horizontal reach of about 1650 mm. The anthropomorphic robotic arms 142,146 complement each other at areas where one of them is unable to reach. The table 172 provides a platform for the exchange of the suction cup and the grasping digits 174.

The lower rail track 144 and the upper rail track 148 may be short pieces instead of one extended piece for easier assembly and transportation. The robot camera 160 near the end effector 162 may provide a visual acquisition of the item to be picked by the anthropomorphic robotic arms 142,146. The acquired image of the item can include the item name, expiry date or best before date which is analyzed by the local computer 164. There can be one robot camera 160 or more than one mounted on its periphery to provide fail-safe and redundancy measures. The end effector 162 which can be a suction cup provides the picking of items with regular surface (flat surface) whilst the grasping digits 174 provides the picking of items with irregular surface such as bottles or pillow bags. The suction is provided by a vacuum.

The freezer 150 provides the storage of frozen items. The chiller 152 provides the storage of chilled items. The ambient storage 154 provides the storage of items that are not temperature critical. The inventory storage 156 provides the storage of items for replenishment or return. Items on the inventory storage 156 are deposited by the vending technician 118 so that the anthropomorphic robotic arms 142,146 are able to pick and put at the appropriate storage section which include the freezer 150, the chiller 152 and the ambient storage 154.

The automatic door 158 particularly at the freezer 150 and the chiller 152 may provide an insulation from the ambient temperature keeping stable cold temperature stable within the freezer 150 and the chiller 152. The temperature of the freezer 150 may be below zero degrees Celsius and the temperature of the chiller 152 may be less than fifteen degrees Celsius.

The vending camera 198 inside the automatic vending store 100 may provide a visual inspection of the operations of the anthropomorphic robotic arms 142,146 as well as the vending technician 118 who is delivering the items to replenish or to collect. The vending camera 198 may also provide security video footage if there were any break in or any unauthorized tampering by the vending technician 118 or any other people.

The function of labelling the individual compartments provide an electronic tagging thereof. The barcode labelling is used as it is cheap to implement. Alternatively, a more sophisticated two-dimensional machine readable code like Quick Response (QR) code can be used. QR code may be able to contain more information compare to the simple barcode. The 128A barcode is used as it can encode ASCII characters (0-9, A-Z and control codes) which is adequate for the current labelling. UPC is commonly used by item manufacturers and provides tracking of the items both for inventory tracking and point of sale tracking.

The mobile device 202 provided in FIG. 4 enables the vending technician 118 to replenish and to collect the items from the automatic vending store 100. The software application in the mobile device 202 provides an interface between the mobile device 202 and the vending technician 118. The software application communicates with the local computer 164 via a communication module in the mobile device 202. The local computer 164 resides in the automatic vending store 100 and also has the communication module therein. The software application enables the vending technician 118 to perform stocktaking. The stocktaking process will be described in detail in the later part. Additionally, the mobile device 202 provides picture and/or video taking of the status of the automatic vending store 100. The location of the vending technician 118 can also be tracked by a global positioning system (GPS) which is built in the mobile device 202.

The communication module may include a wireless module which communicates using Wi-Fi based on the IEEE802.11 or 3G, 4G LTE (4^{th} Generation Long Term Evolution). Wi-Fi may be used for local area network where there is a local router proximal to the mobile device 202. The local router inevitably has to connect to a network port which is usually on a wall. The connection may be a twisted cable pair usually a CAT 5 cable with a RJ45 terminator connected to a corresponding RJ45 female network port on the wall for Internet access. Alternative wireless connection between the mobile device 202 and the local remote computer 164 can be achieved by using Bluetooth.

3G, 4G LTE are provided by carriers like Singtel, M1, Starhub, Verizon, AT&T, NTT Docomo (telco providing infrastructure to enable mobile data communication and telephony). The wireless communication may be important for the mobile device 202 for mobility. Conversely, a wired communication may restrict the mobility in handling the mobile device 202 making stocktaking cumbersome and hence contrary to being productive. The wireless communication between the mobile device 202 and a remote computer located at a remote location can be achieved using the network infrastructure provided by the carriers (Telco). Likewise, the wireless communication between the local computer 164 and the remote computer is also possible. The remote computer can also assume the responsibilities of the local computer 164.

However, in the event that there is no Wi-Fi (void of local network) and no network service available which may happen, the vending technician 118 has the option to plug into a standard connector like a USB (Universal Serial Bus) Mini-A of the mobile device 202 using a spring insulated cable (coiled cable) which is extendable and retractable. The other end of the spring cable connects to a USB Type A connector of the local computer 164.

The local computer 164 provides technical functions such as first, controlling the motions of the two anthropomorphic robotic arms 142,146 mounted on the two rail tracks 144,148.

Second, storing information with regards to the items inside the automatic vending store 100. The information may contain a brand, a category (beverage, food, snacks, etc.), a temperature classification (frozen, chilled, normal), a best before date (or expiry date), an in-store date (the date when the item is inside the vending store 100), an out-store date (when item is sold or rejected if defective), an item description (description for the consumer to read), an item retail price, a quantity of the item, an image of the item, a contact information of the supplier of the item (if the stock is low, contact supplier to replenish). The mentioned information is non-exhaustive and can contain miscellaneous information of the item. The supplier can either be the vending technician 118 who is an employee of the vending store 100 or can be the actual supplier of the item.

Third, the local computer 164 may keep a log (time and video footage) of the access of the automatic vending store of the vending technician 118.

Fourth, the local computer 164 may keep a record of the items sold and the revenue generated therefrom.

Fifth, the local computer 164 may capture the information of the consumer who purchases the item from the store 100. The consumer information may include a first name, a last name, an electronic email, a contact phone number, a date of birth, a gender, a photo identification, a voice recording, etc., a record of the past purchases (for an improved consumer buying experience). Based on the past purchases record, the local computer 164 can suggest to the consumer relevant items or familiar items to buy. The captured information can also be used to present to prospective advertisers, item suppliers to encourage them to leverage on the presence of the automatic vending store 100, in particular, the demographics of the consumers, items that are regularly purchased. Hence, increasing the revenue of the vending store 100 and also helping advertisers and suppliers in their market outreach and expanding their brand presence.

Sixth, the local computer 164 may have communication with a plurality of temperature sensor located at temperature critical sites like the freezer 150 and the chiller 152 to detect temperature fluctuations.

Seventh, the local computer 164 may gather information with the consumer through cameras (image sensors), microphones (audio sensors) 124, inputting devices such as the keypad and the tactile display screen 102. Other means of gathering information can be from the Internet provided there is communication available specifically through social media such as Facebook. The consumer can log in his or her registered account of the automatic vending store 100 to fetch personal information from the Facebook and populate the record in the local computer 164. In a same way, information like item purchased can also be uploaded to the registered and verified consumer's Facebook account to provide an interactive purchasing experience. The experience is shared to the consumer's contact list which helps to promote the presence of the automatic vending store 100.

Eighth, the local computer 164 may output information to the consumer through the tactile display screen 102 which is the primary mode of output communication between the consumer and the local computer 164. Additionally, the local computer 164 controls the operations of the anthropomorphic robotic arms 142,146 and other external peripherals which are inconspicuous to the consumer.

In essence, the local computer 164 may provide information gathering, processing, storing and based on the information controls the external peripherals to perform a desired outcome to fulfil the demands of the consumer. The demand pertains to the sales of items, the timely and relevant item information presentation to enable the consumer to make an informed decision on his or her purchase. The local computer 164 has a memory storage to enable it to store the information aforementioned.

The local computer 164 and the external peripherals which may include the tactile display screen 102, the dispenser 104, the payment terminal 106, anthropomorphic robotic arms 142,146, the freezer 150, the chiller 152, the lightings in the static advertisement section 116, the at least one vending camera 198, the robot cameras 160 may be powered by an electrical grid which supplies a root mean square (RMS) mains voltage of 240 Volts AC. All the external peripherals including the local computer 164 use a voltage less than the mains voltage. Therefore, a step-down transformer may be used to decrease the voltage to an appropriate voltage which is suitable for the individual peripheral and parts. To ensure a continuous electrical supply to the automatic vending store 100, the mains may be connected to an uninterrupted power supply (UPS) prior to supplying thereto. In the event of a power outage, the UPS can continue to operate for a determined period of time to make sure all information is uploaded to the remote server or backed up. After which the automatic vending store 100 prepares to shut down if the electrical supply is not resumed. Alternative power source can be from a plurality of solar panel which converts light from the Sun and convert to electrical energy which is stored in a battery and consumed by the automatic vending store 100.

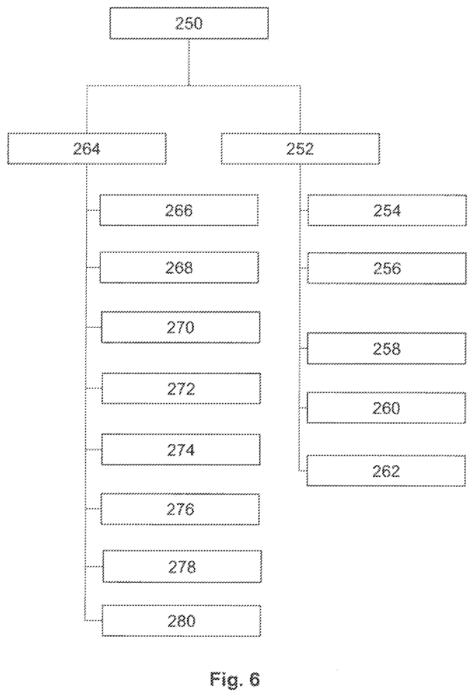

In use, the automatic vending store 1 00 may provide two modes of operation 250, a consumer mode and a store mode as shown in FIG. 6. The consumer mode may pertain to the interactions of the consumer and the automatic vending store 100. The store mode may pertain to the background activities that makes the automatic vending store 100 operational and ready to serve the consumer.

The store mode 252 may further include detecting the availability of at least one item 254, entering an item specification for the at least one item 256, dispensing the at least one item 258, tracking the at least one item 260 and replenishing the at least one item 262.

The consumer mode 264 may further include tracking of at least an eye 266, tracking of gestures (hand/body) 268, recognizing a voice 270, registering (web/vending store) 272, selecting the at least an item 274, requesting payment 276, identifying facial features 278 and suggesting items 280.

For illustrative purpose, the item is assumed to be a box of ice-cream which is to be stored in the freezer 150 on the first shelf 204 in the first compartment 208. The first compartment has a unique identifier, F1 S1 C1.

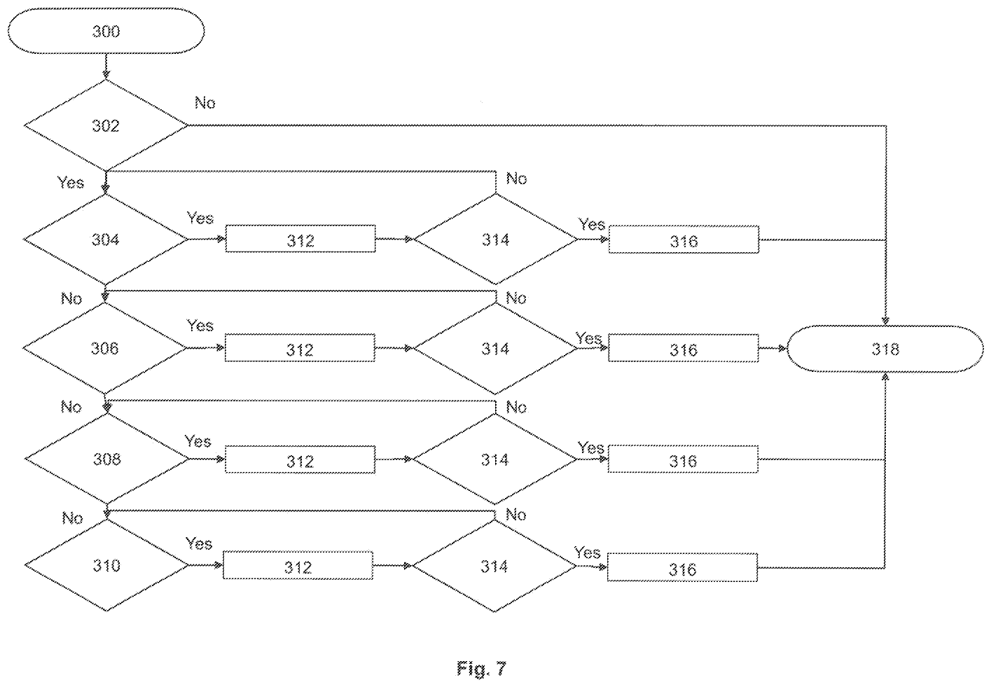

FIG. 7 illustrates a method of detecting the availability of at least an item 300 in a compartment 208 including the steps of first, identifying a disruption of signal of the photoelectric sensors 302. Secondly, identifying the location of the disruption, the freezer compartment 304, the chiller compartment 306, the ambient storage compartment 308 or the inventory storage compartment 310. If the disruption is located at the freezer compartment, the physical quantity will be increased by one 312. Thirdly, is to check whether the maximum allowable items in the compartment 208 has been reached. Fourthly, is to record the final count 316 of the quantity in the compartment 208 into the memory storage of the local computer 164. The detecting of the item comes to an end 318.

In detail, a plurality of diffuse photoelectric sensor 222 is installed at the ingress of F1 S1 C1, in particular, at the top front of the compartment which has an automatic door 158. Each time a body (human body or hand) which can be either the anthropomorphic robotic arm 142,146 or the hand of the vending technician 118 approaches the automatic door 158, the photoelectric sensor 222 is triggered and the automatic door 158 opens. The automatic door 158 is in a normally closed position to ensure that the inner cold temperature is maintained.

Alternatively, the automatic door 158 may be opened by the local computer 164. Since the local computer 164 has the foreknowledge of the movement of the picked item by the lower anthropomorphic robotic arm 142 from the inventory storage 156 to the freezer 150 at F1 S1 C1 and a known distance, the local computer 164 may send a control signal to open the automatic door 158 corresponding to F1 S1 C1. However, doing so assumes that the time to pick the item from the inventory storage 156, travelling on the lower rail track 144 and to the freezer 150 are measured, calculated and verified which makes troubleshooting and expansion in the future difficult.

Inside the compartment is the detachable tray 218 as shown in FIG. 4, there may be a different set of diffuse photoelectric sensors 222 mounted on the strip of breadboard 220 at regular intervals. The strip 220 is installed along a length of the detachable tray 218. The strip 220 may be like a breadboard with two rows of electrical conductor extending parallel along its length. The strip 220 may be insulated exposing a plurality of perforation along the two parallel rows; one perforation above the first row which is an electrically positive channel (+) or a signal in and the second perforation above the second row which is an electrically negative channel (−) or signal out. The two adjacent perforations may provide an insertion of the one photoelectric sensor 222. The one photoelectric sensor 222 may have two leads typically a positive lead (+) and a negative lead (−). There plurality of perforation may provide different insertion positions and more than one photoelectric sensor 222 can be inserted. There can also be a third row which runs parallel to the first and the second row which is a ground (earth).

For example, the length of the detachable tray 218 may be three hundred and twenty millimetres (320 mm). A breadth of the box of ice-cream may be fifty millimetres (50 mm) which equates to six boxes of ice-cream can be put inside the compartment with an excess space of twenty millimetres (20 mm). Based on the above measurement, there may be at least six photoelectric sensors 222 spaced evenly at about twenty-five millimetres (25 mm) along the strip measuring three hundred millimetres (300 mm). The detection of the presence of the item depends on the position of the photoelectric sensors 222.

Initially, the strip 220 may be configured to read or accept six boxes with the correct placement of the photoelectric sensors 222. The strip 220 is then installed inside the detachable tray 218, F1 S1 C1 with a one end of the strip having a female coupler connected to a male connector at the rear end of the detachable tray 218 which supplies electricity and control signals to the photoelectric sensors 222.

The opening of the automatic door 158 may signal that an item (box of ice-cream) is either going inside or coming out of the compartment, F1 S1 C1. Initially, the compartment, F1 S1 C1 is vacant the box of ice-cream is picked from the inventory storage 156 and loaded into the detachable tray 218 at compartment (F1 S1 C1) by the lower anthropomorphic robotic arm 142. The photoelectric sensors 222 inside the detachable tray 218 are initially not triggered (light unblock) implies vacant. The automatic door 158 may open when the lower anthropomorphic robotic arm 142 approaches, pre-empting (switching on) the photoelectric sensors 222 inside the detachable tray 218. The lower anthropomorphic robotic arm 142 with the box of ice-cream may be loaded directly to the rear end of the detachable tray 218 at the compartment F1 S1 C1 which disrupts the light beam signaling a presence of an object. This signal may be sent to or sensed by the local computer 164 which records as one item (box of ice-cream) in F1 S1 C1.

The signals from the photoelectric sensors 222 may be sent to the local computer 164 for counting The disrupted light beam of the photoelectric sensor 222 may indicate that there is an item in the compartment. If not disrupted, it would imply that the compartment is vacant. Another possible scenario is the photoelectric sensor 222 may be faulty and therefore the vending technician is replenishing has to ensure that the final physical item count matches the count done by the local computer 164. If the photoelectric sensor 222 is faulty, a replacement is easily made by pulling the faulty photoelectric sensor 222 from the strip 220 and replacing with an operational photoelectric sensor 222.

The algorithm in the local computer can count the items in all compartments 208 but unable to identify the nature of the item and the brand. Therefore, the vending technician 118 has to manually enter (scanning barcodes of the labels on shelves and the item) the association, for example, item found in the inventory storage 156 on shelf one, compartment four (IS1 S1 C4) is to be picked and loaded into the correct the freezer 150 on shelf one and compartment 2 (F1 S1 C2). The algorithm may determine exactly where the items goes to from the inventory storage 156.

Any addition of the same item into the same compartment increases the quantity and may be directly recorded by the local computer 164. Ideally, one compartment stores items of the same kind. However, different items may be stored in the one same compartment with the position of the photoelectric sensors 222 on the strip changed. The local computer 164 also has to be informed with such a configuration through software algorithm which will be described.

The same method applies for the chiller 152 and the ambient storage 154. The ambient storage 154 does not have an automatic door 158. The strip is also installed in the chiller 152, the ambient storage 154 and the inventory storage 156 to provide real time inventory status.

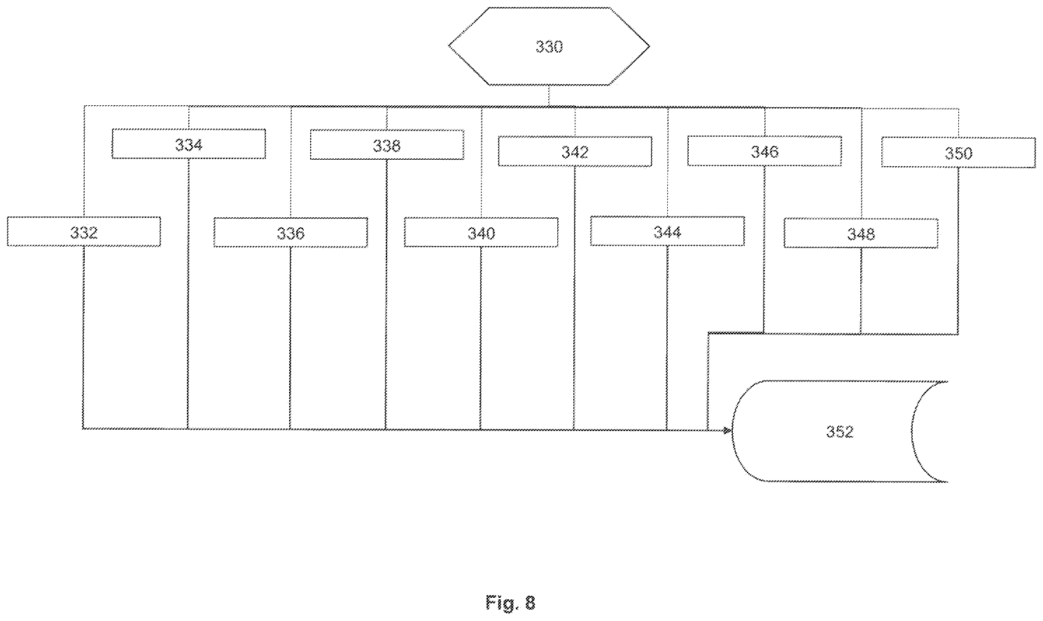

FIG. 8 illustrates a method of entering item specifications for at least an item including the following steps of first, encoding the item specifications in a machine and human readable file 330, for example a XML (extensible Markup Language) file. The file may be done off-site preferably at a fulfilment or warehousing centre. The file is in digital copy saved in a portable storage medium, for example a USB (Universal Serial Bus) thumb drive. Alternatively, the file can be transmitted to the automatic vending store 100 via a network from the remote server.

The item specifications including an automatic vending store code 332, a source storage section name, a source shelf number, a source compartment number 334, a target storage section name, a target shelf number, a target compartment number 336, a universal product code (UPC) 338, an item brand 340, an item price 342, an item best before date or expiry date 346, an item origin 348 and an item description 350. For example, the XML file contains the following structure:

```
<vending_12345>
  <sourcestoragesect>IS1 </sourcestoragesect>
  <sourceshelf>S1 </sourceshelf
  <sourcecompartment>C1 </sourcecompartment>
  <targetstoragesect>F1 </targetstoragesect>
  <targetshelf>S1 </targetshelf
  <targetcompartment>C1 </targetcompartment>
  <upc>123456789000</upc>
  <brand>Meadow Gold</brand>
  <item_price>10.00</item_price>
  <item_type>frozen<item_type>
  <best_before>201812</best_before>
  <origin>Singapore</origin>
  <description>Six decadent ice-cream cones that delight your senses.
  </description>
</vending_12345>
```

The encoded instruction above specifies the source of the item on the inventory storage 156 and the target storage section at the freezer 150. Subsequent items insertion into the XML file will follow the above structure.

Secondly, the encoded file (XML) may be loaded into the memory storage (hard disk) 352 of the local computer 164 through a communication port like a USB serial port or through a network interface card (NIC) which is connected to the network via a cable or the wireless router. Once the XML file is loaded, the algorithm in the local computer 164 has the knowledge of all items in the storage unit.

The local computer 164 may verify the information provided by the XML file by performing a count of all items in all the compartments in all the storage sections through the plurality of sensor. Besides the photoelectric sensors 222, there may be infrared sensors 223 mounted on the strip 220 as well to scan for the UPC on the items. The scanning of the UPC may provide the possibility of having dissimilar items in one compartment as location tracking is made possible. Alternatively, a tray camera 224 may be installed above the items in the detachable tray 218 which may be able to slide longitudinally along the detachable tray 218 and is used to acquire images of the items. The acquired images are processed and verified by comparing with the stored information at the local computer 164. The image recognition of the item primarily seeks out a logo on the item, the dimensions of the item et cetera. The movement of the tray camera 224 is controlled by the local computer 164.

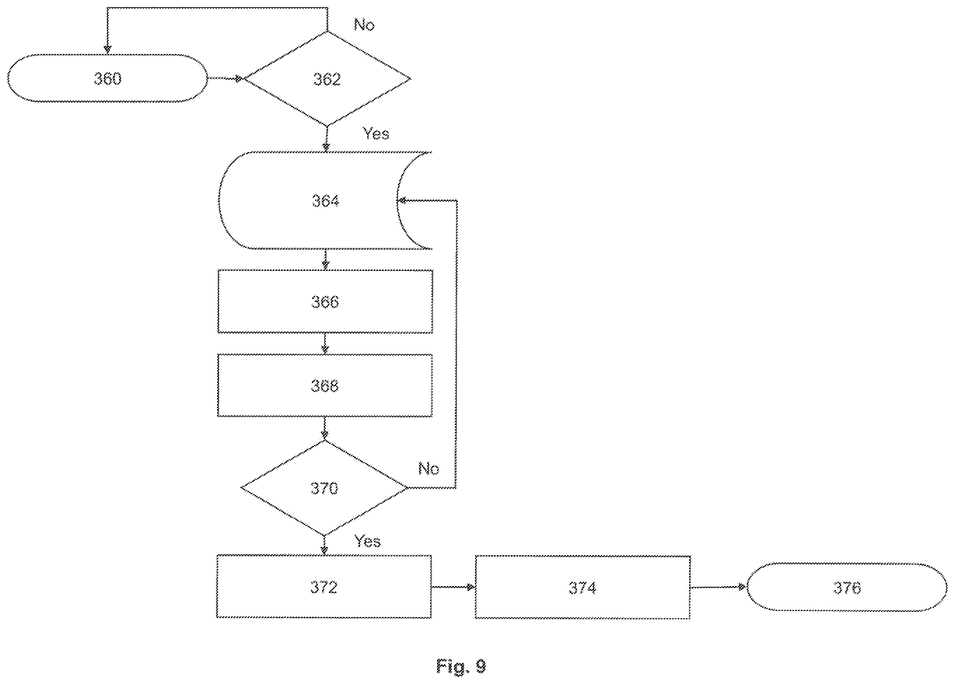

FIG. 9 illustrates a method of dispensing the at least one item 360 including the following steps of first, receiving the selection of the item 362 from the consumer via the tactile display screen 102. Secondly, the relevant anthropomorphic robotic arm 142,146 is activated 366, picked up the item from the correct compartment as instructed by the data file 364 stored in the local computer 164. Thirdly, the photoelectric sensor 222 located in the detachable tray 218 detects for light disruption 370 to indicate the item has been picked 368 up by the robotic arm 142. The picking of the item is further confirmed by another sensor on the anthropomorphic robotic arm 142,146. The quantity of the item in the compartment 208 is decreased by one 372. Fourthly, the robotic arm 142 deposits the item 374 into the pivotal trough 166 of the dispenser 104. Fifthly, the pivotal trough 166 pivots and drops the item onto an inclined plane 168 and drops into a collection trough where the consumer picks the item and the dispensing of item ends 376.

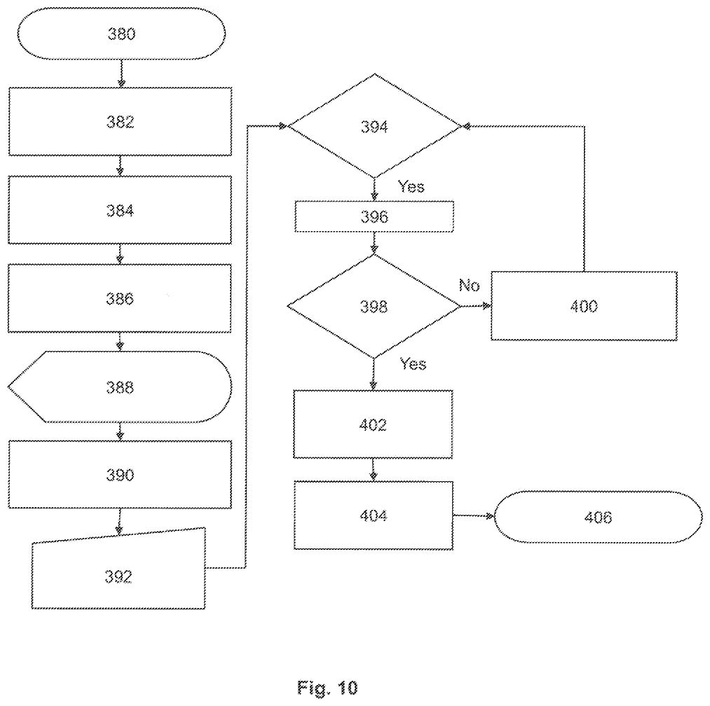

FIG. 10 illustrates a method of stocktaking 380 including following steps. Firstly, the vending technician 118 switches on the location-based tracking 382 of the mobile device 202 (a smartphone with camera and app ready) to indicate the location of the automatic vending store 100. The relevant data file 384 is loaded to the mobile device 202 wirelessly from the remote computer. The data file contains the information of where the items are to be placed in the inventory storage 156. Alternatively, the data file is already in the mobile device 202. Based on the location of the automatic vending store 100, the relevant data file is displayed.

The vending technician 118 may use his mobile device 202 (a smartphone with camera and app ready) to scan the barcode (UPC) of one of the items 386. The display screen of the mobile device 202 may display the item location 388 in the inventory storage 156. The item location may also be based on the location of the automatic vending store 100. The mobile device 202 itself may have a GPS (Global Positioning System) that provides the location thereof. Different automatic vending stores 100 may have different item placement on the inventory storage 156. Therefore, scanning the UPC of the item and couple with the location of the automatic vending store 100 will display the exact item location in the inventory storage 156.

The vending technician may then place the items 390 into the individual compartments 208 of the inventory storage 156. The individual compartments 208 may have individual detachable tray 218 therein. The mention of compartment 208 may assume that detachable tray 218 is inside which has a strip 220 of sensors 222,223. Take the example of the boxes of ice-cream. Five boxes of ice-cream were to be placed on the first shelf (S1) in the first compartment (C1) of the inventory storage 156 (IS1 S1 C1) based on the instructions shown on the mobile device 202. The vending technician 118 activates an app (software application) on his mobile device 202, scans the UPC printed on one ice cream box using his mobile device 202 and enter the physical quantity (numerical 5) 392 using the same mobile device 202 via the display screen.

The local computer 164 may be fully aware of the inventory status of the compartments in all the storage sections. The algorithm in the local computer 164 may cooperate with the photoelectric sensors 222 located in all the compartments to know the inventory status. The algorithm accordingly highlights the shortfall and instructs the remote computer (can be a supplier's computer or backend fulfilment centre computer or a warehouse computer) on the current demands of that particular automatic vending store 100 with a date and timestamp. For example, the local computer 164 detects there is one box of ice-cream in the freezer, shelf one, compartment one (F1 S1 C1). That compartment can store six boxes in total. The shortfall is five (6−1=5) boxes. The algorithm calculates the shortfall and inform the remote computer.

Just in case the vending technician 118 did not bring five boxes of ice-cream to the automatic vending store 100, he can input the actual physical quantity, and the algorithm will confirm the entry of the vending technician with the inputs from the photoelectric sensors 394,396 that are located at the inventory storage 156. The inputted physical quantity on the mobile device 202 is then uploaded wirelessly to the local computer 164 where the algorithm will verify with its input readings from the photoelectric sensors 398. This is the stage where troubleshooting can take place. If the inputted physical quantity and the input readings from the photoelectric sensors 222 differ, it would imply that one of the photoelectric sensors 222 is defective and need to be replaced 400.

The local computer 164 will then base on the input data file such as the XML file as described earlier to instruct 402 the anthropomorphic robotic arms 142,146 to pick up 404 the boxes of ice-cream from the inventory storage 156 to the freezer 150. As mentioned the XML file can be prepared and loaded into the local computer 164 either by the vending technician 118 or received from the remote computer via Internet. Both methods present pros and cons. The process of stocktaking ends 406.

If efficiency were demanded, then the latter method is recommended. However, sending the XML file remotely is based on the assumptions that the local computer 164 and the input sensors were working in a tip top condition and therefore assume no mistake, the Internet connection is intact and secured. Adopting the former method is less efficient compare to the latter but is more reliable as the vending technician 118 is assumed to be well-trained to tackle the issues on-site.

The item inventory may be checked at the inventory storage 156 by the counting the photoelectric sensors that are disrupted in the individual compartments. Disrupted signal means there is an item. The time of day to make an inventory check of all the storage sections is set by an authorised personnel at a remote site or the vending technician 118. The time is set at off peak hours or where the sales of item is low. The stock level of the storage sections may also be taken on demand (as and when is needed) instead of time based. The authorised personnel at the automatic vending store 100 can retrieve the information while on-site or the remote computer could access any time.

The network connection is established to provide communication with the remote computer. The communication is to provide the status of the item inventory of the automatic vending store 100.

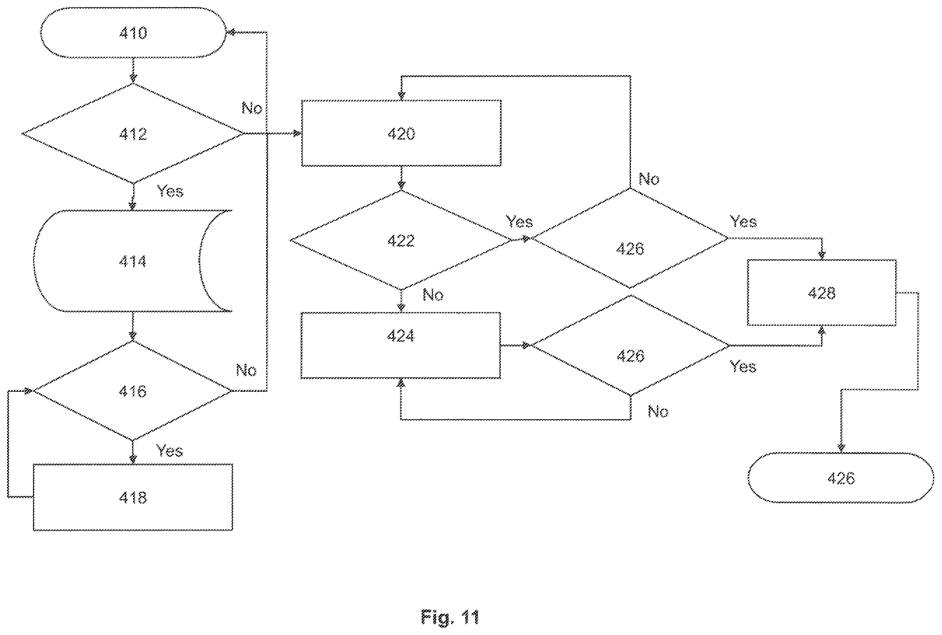

FIG. 11 illustrates a method of arranging the item 410 including the following steps. The algorithm in the local computer 164 refers to the XML data file and check the availability of items on the inventory storage 156 (is there a replenishment?) 412. If there were item left in the inventory storage 156, the algorithm refers to the XML data file 414 to see which compartment does the item goes to. For example, there are five boxes of ice-cream left on the inventory storage 156, the first shelf, the first compartment (IS1 S1 C1). The XML data file states that items from IS1 S1 C1 goes to the freezer 150, the first shelf, the first compartment (F1 S1 C1). The algorithm then checks the F1 S1 C1 for any item therein 416 and found that there is one box of ice-cream inside. The algorithm then instructs the anthropomorphic robotic arms 142,146 to pick 418 the one box of ice cream in the F1 S1 C1 and placed in the inventory storage 156. There is at least one vacant compartment in the inventory storage 156 for temporary storage. Thereafter, the anthropomorphic robotic arms 142,146 then picks up 420 the new boxes of ice-cream from the compartment in the inventory storage 156 as instructed by the XML data file which in this case is the inventory storage on the first shelf in the first compartment (IS1 S1 C1) and put in F1 S1 C1. This process reiterates until there is no more item left in the compartment (IS1 S1 C1) 422. Lastly, the one box of ice-cream left in the vacant compartment in the inventory storage 156 is picked 424 and placed in F1 S1 C1 This ensures that the first to enter (replenishment of the item) the storage section is the first to leave (sale of the item) the storage section. The storage section includes the freezer 150, the chiller 152, the ambient storage 154 and the inventory storage 156.

During each picking and depositing at the target compartment which in this case is F1 S1 C1, the algorithm checks whether there is enough space for more items in the target compartment 426. If there were not enough space, an error message, “Not Enough Space in the target compartment” will appear 428 at the display screen of the mobile device 202.

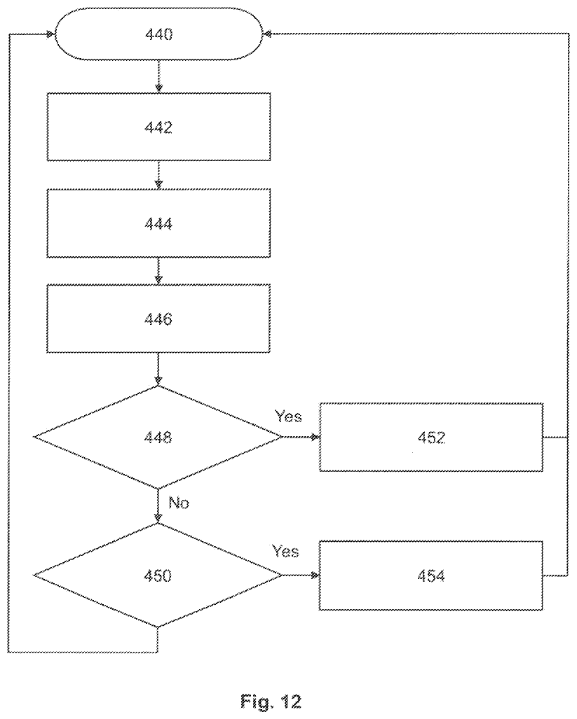

FIG. 12 illustrates a method of detecting the ambient temperature 440 for item suggestion including the following steps. The ambient temperature relates to the temperature of the outdoor environment. Alternatively, the temperature can be acquired from a website on the Internet such as the accuweather.com where a software API (application programmable interface) can be developed to get constant update of the ambient temperature. More than that, local weather condition can also be acquired.

The temperature sensors may be located at the front side of the automatic vending store 100. At least one temperature sensor may be located at the front base 442 and at least one temperature sensor is at the front top 444. The readings from the temperature sensors are acquired and an average reading 446 of the two temperature inputs are computed by the local computer 164. The result may be used to suggest item to the consumer. For example, if the average ambient temperature is 30 Degrees Celsius 450, the local computer 164 may suggest a cold beverage to the consumer 454. If the ambient temperature is 20 Degrees Celsius 448, the local computer 164 may suggest a hot beverage to the consumer 452. In the same vein of thought for example, on a rainy day, a suggestion to buy an umbrella to the consumer is possible.

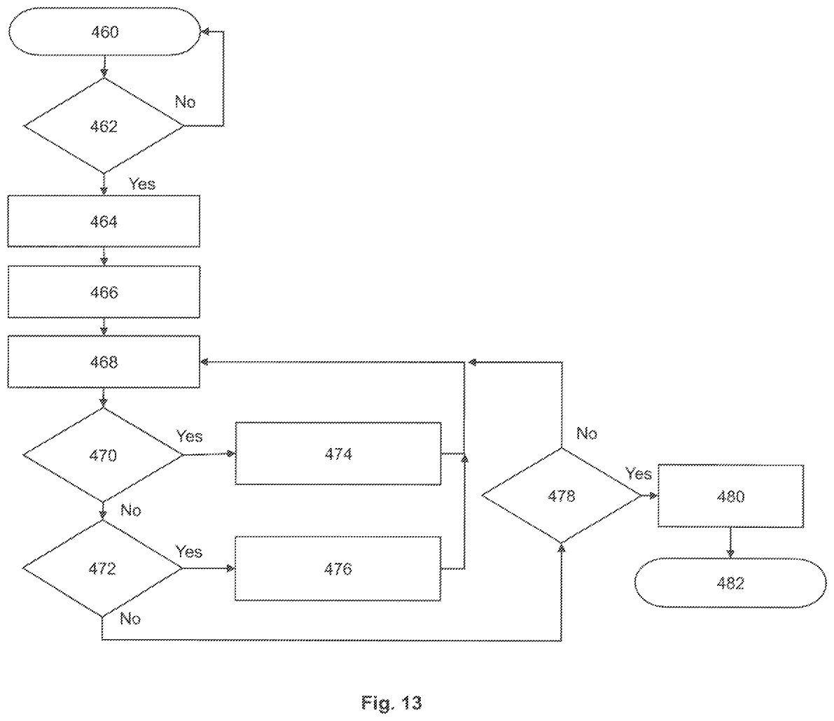

FIG. 13 illustrates a method of tracking a gesture of the consumer specifically the eye 460 using the at least one vending external camera 120 including the steps of first, tracking or locating the face 462 of the consumer to ensure a real human is present. The vending external camera 120 is installed on the front side of the automatic vending store 100 and on the right side of the tactile display screen 102. The algorithm tracks the face containing the features of two eyes, one mouth, one nose and two ears set in an elliptical shaped frame. At this juncture the identity of the consumer is not established. Secondly, the location of the eyes 464 is identified by using a relative distance from the forehead or periphery of the elliptical shaped frame. Thirdly, the eye focus is determined by detecting the presence of the sclera and an iris 466 from the captured image. For example, if the consumer were to glance to the left side 472, the right side sclera will be more obvious compare to the left side sclera as the iris is shifted to the left side. The left glance will scroll the selection menu to the left 476 and reflected on the tactile display screen 102. Conversely, if the consumer were to glance to the right 470, the selection menu will scroll to the right 474. Fourthly, to effect a selection 480, the consumer has to blink two times 478 in rapid succession by looking at the item on the tactile display screen 102. And that is the end of the process of eye tracking in the scrolling and the selection of the item 482.

A certain margin of allowance is provided as the vending external camera 120 is not at the true centre of the tactile display screen 102. It is assumed that the consumer stands in front of the tactile display screen 102. Alternatively, the vending external camera 120 can be located at the top centre frame of the tactile display screen 102. The current method enables a handicap person or wheelchair bound person to make a purchase without moving using his or her arm.

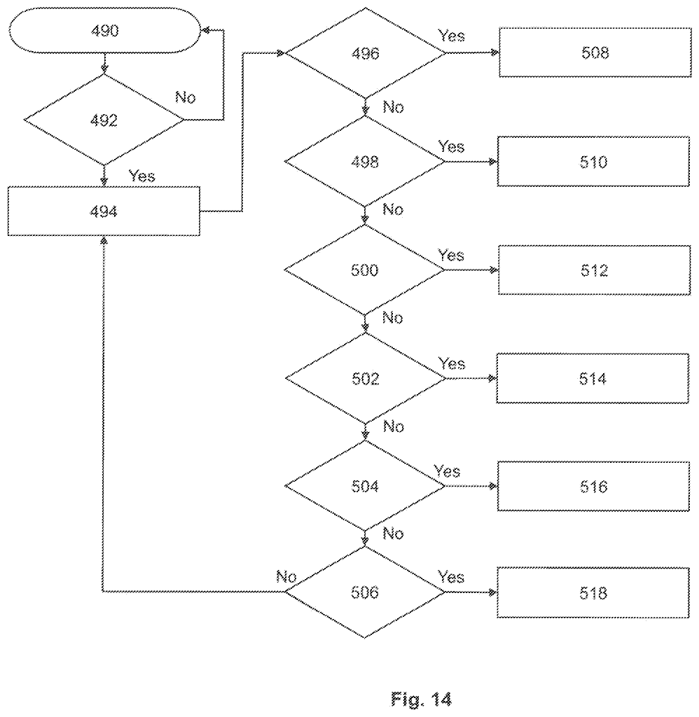

FIG. 14 illustrates a method of tracking a gesture of the consumer specifically the body movement like hand gesture 490 using the at least one vending external camera 120 including the steps of first, locating the face of the consumer 492. This is to ascertain that a human consumer is standing in front of the automatic vending store 100. An approximate estimation of the body parts of the consumer are identified taking reference from the face. Assuming that the consumer is physically abled, a second step is to identify the position of the hands and tracked 494. Hence, the consumer will intuitively raise his arm to a level that is somewhere at the front centre of the tactile display screen 102 where the vending external camera 120 may be able to capture. The consumer can articulate his selection by moving his one hand, either a left hand or a right hand without touching the tactile display screen 102. By simply, expressing a pointed finger, the consumer can select and confirm his selection. The consumer can also scroll between selection by moving his finger left 496 or right 498, up 500 or down 502 in the conical line of sight of the vending external camera 120 representing scrolling the selection to the left 508 or right 510, up 512 or down 514 respectively.

Below is a list of possible hand gestures and its corresponding commands supporting the latter method.

A pointed finger suggests a selection; An open palm that eventually ends in a clenched fist or grip 504 in a time of one second or less suggests a confirmation 516. From a clenched fist to an open palm 506 suggests abandoning the selection or deselect 518. In other words, a gripping and a non-gripping motion; A sweeping motion of the hand or pointed finger to the left 496 suggests scrolling the current page to the left 508. Conversely, a sweeping motion of the hand to the right 498 suggests scrolling the current page to the right 510; A sweeping motion of the hand or pointed finger upwards 500 suggests scrolling the current page upwards 512. Conversely, a downward sweep 502 of the hand suggests scrolling the current page downwards 514; A plurality of outstretched fingers presumably four and a one thumb suggests an expanded view. Conversely, the four fingers and the one thumb gather in a point suggests a minimized view.

The local computer 164 having the memory storage has all the possible gestures of the eye, the hand, the human body so as to accurately interpret each gesture with the corresponding command. Additionally, the identification of the gestures can also be used to interpret the emotional state of the consumer. For example, anger, anxious, happy.

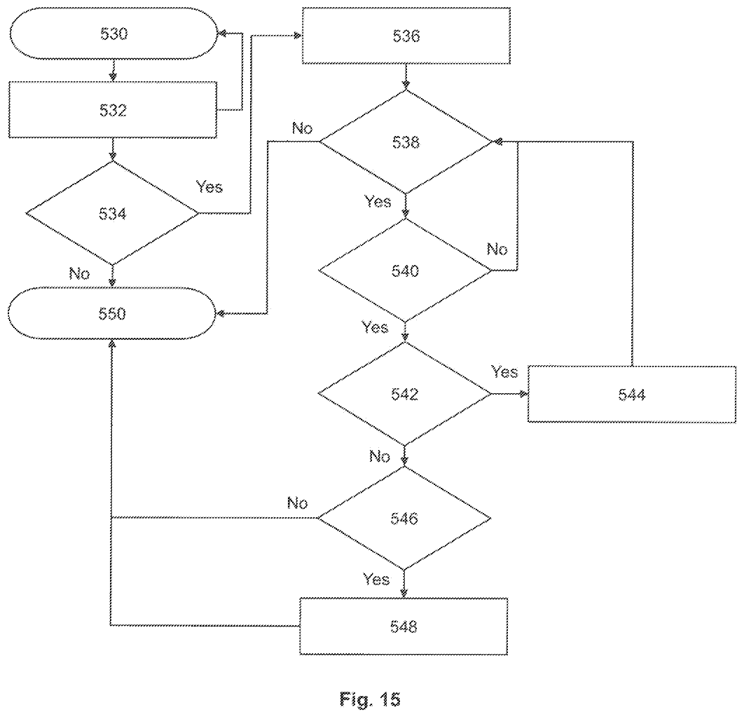

FIG. 15 illustrates a method of interpreting the voice 530 into a list of corresponding command including the steps of first identifying the harmonics of the human voice 532 using the microphone 124. The voiced speech of a typical adult male will have a fundamental frequency from 85 Hertz to 180 Hertz, and that of a typical adult female from 165 Hertz to 255 Hertz. Thus, the fundamental frequency of most speech falls below the bottom of the “voice frequency” band (300 Hertz to 3,000 Hertz). However, enough of the harmonic series will be present for the missing fundamental to create the impression of hearing the fundamental tone.

Secondly, matching the harmonics 534 with the saved harmonics in the memory storage of the local computer 164. Thirdly, interpret the harmonics to the corresponding command. For example, changing the display on the tactile display screen 102 to reflect the prospective consumer's item preference. The automatic vending store 100 initiates a voice 536 asking the consumer for a response.

The item will have identification label such as“A1” corresponds to an ABC apple juice. Instead of reciting the item description, the consumer can recite the corresponding identification label to make a selection 538. Saying “Confirm” 540 will confirm the selection. Saying “Pay” 546 will proceed to payment 548. Saying “Yes” to acknowledge or to proceed. Saying “More” will show more selections. Saying “Add” 542 will return back to the selection menu to add more item and the selected item placed in a shopping cart 544. The voice recognition process ends 550 after the payment is made by the consumer.

More commands and languages can be added into the memory storage. The local computer 164 may ask leading questions to prompt the consumer to simply answer in mono-syllable words such as “Do you want to carry on shopping? Answer Yes or No.” using the speaker 126. The voice activated automated vending store 100 provides an easy shopping for the visually impaired which will mean that the items in the selection menu need to be read out using the speaker to make shopping viable for the latter consumers. Alternatively, the algorithm in local computer 164 may be able to discern and recognise the different voices and lookup specific keywords that is pertinent to the functions of the automatic vending machine. For example, if the consumer says“I want an apple juice”, the algorithm can pick up the key word “apple”. The word “apple” is listed as one of the key words in the data file during the item replenishment which is stored in the memory storage.

The gesture and voice recognition have not specifically delved into the identity of the consumer. They are simply to interact with the prospective consumer standing in front of the automatic vending store 100.

The facial identification of the consumer may be made possible if either the consumer has registered with the automatic vending store 100 or the local computer 164 has the computing prowess to search the Internet via the service provider at high speed searching for a matching facial features of the unregistered consumer. The latter identification process is time consuming and assuming the unregistered consumer has left his or her photo identity on the Internet or leave a significant digital footprint on the Internet. To simplify the search, the unregistered consumer could enter his name guided by instructions on the tactile display screen 102. More information provided will simplify the search. The search can extend to social media like Facebook, Instagram, Pinterest, Google Plus et cetera.

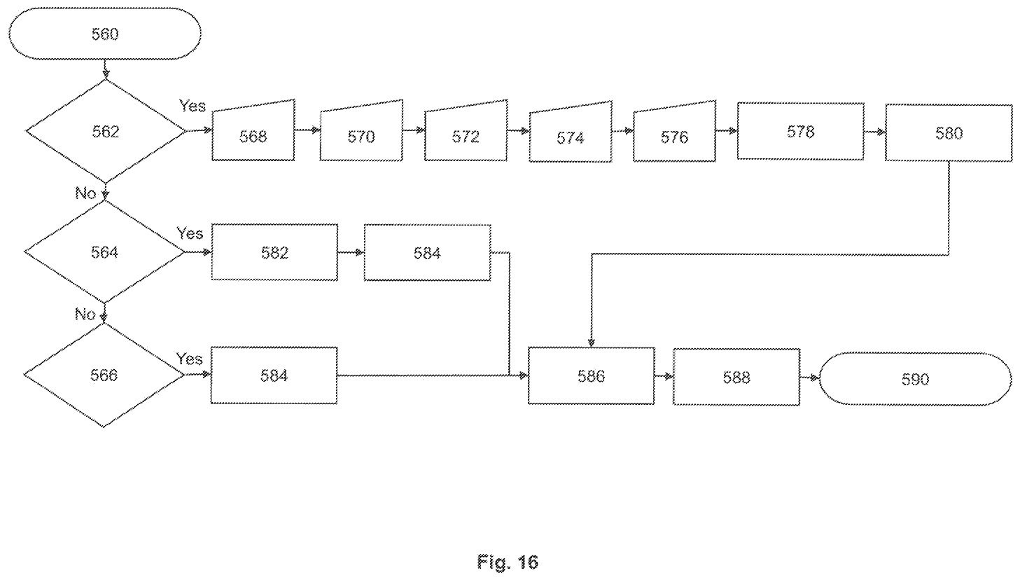

FIG. 16 illustrates a method of registering a new member 560. In the new member registration, the new member touches a button 562 on the tactile display screen 102 on the automatic vending store 100 that indicates a “New Member”. Alternatively, if it is by a voice activation 564, simply say “New Member”. Another alternative, if it is by an eye activation 566, the eye movement controls a cursor on the screen that navigates to the “New Member” button.

An online form may be fetched from the remote computer via the network and is displayed prompting for a first name, a last name 568, a gender (male/female) 570, a date and year of birth 572, a smart phone number 574 and an electronic mail address 576. The new member's facial features are recorded 578 by the vending external camera 120. The new member's voice 580 is also recorded by the microphone 124. The tactile display screen 102 will display a sentence and expect the new member to recite. For example, “Hello John, you look great”. The sentence structure contains vowels and consonants that covers most of the English phonetics as well as the vocal range of the new member. For other languages and commands, the memory storage of the local computer 164 has to be updated accordingly. A virtual keyboard is displayed on the tactile display screen 102 as an input means for the tactile input and using eye movement.

Similarly, for the voice activated registration, the vending store may initiate voice instruction to guide the new member to register 582 and acquiring the same information as the tactile input 562. As for the eye activation registration, the same information is acquired 584. However, if the new member is unable to speak the voice recording 580 would be skipped. On each input step, permission is sought from the new member to get information. However, information like name, phone and email are compulsory fields to be entered for identity authentication and verification.

The completed form may be submitted and transmitted via the network to the remote server of the vending store owner. A message may be sent to the mobile phone of the new member to verified the entries 586. The message may contain a series of alphanumeric characters. The message instructs the new member to enter the series of alphanumeric characters into the automatic vending store's tactile display screen 588. The member registration process ends 590.

To leave an impression on the new member, a membership card having NFC capability can also be dispensed from the automatic vending store 100. The membership card having the name of the registered member printed on one surface. The registration of the new member is completed and is now a registered member.

The registration can be performed on a web browser on a desktop, a laptop, a smart phone, a tablet or a mobile application developed specifically for the smart phone. For new members who registered, an incentive is given as an appreciation by providing discount in the next transaction, for example, purchasing at least an item from the automatic vending store 100.

The registered member begins to perform a transaction by touching on the tactile display 102. A message “Member?” with two buttons “Yes” and “No” are shown on the tactile display screen 102. The registered member selects “Yes” by touching the“Yes” button on the tactile display screen 102. If the consumer touched “No”, a message “Do you want to register?” is displayed on the tactile display screen 102. If the consumer persisted in not registering, the local computer 164 will suggest items based on the ambient temperature and the facial features. For example, if the ambient temperature is 30^{Q}C, the local computer 164 will suggest cold beverages. In addition, the vending external camera 120 will detect for a human face and process the acquired image to determine the gender of the consumer. If the consumer were a man, the local computer 164 may suggest a beer as beverage. Conversely, if the consumer were to register, the consumer will be directed to the registration.

The registered member waves its smart phone or the membership card near the reader module 120. The registered member's particulars are retrieved from the remote computer (can be the automatic vending store's remote computer or server). Relevant ads are displayed on the top and/or bottom pane of the tactile display screen 102. The ads relate to the registered member's buying habits based on past shopping experience and also showing new item offerings relevant to the registered member. The remote computer returns with a result confirming the status of the member. The remote computer also suggests relevant items relating to the registered member. If there were only one automatic vending store 100 then it makes sense to store the information of the member to the local computer 164. The use of the remote computer makes sense for multiple automatic vending stores 100 at different sites. Of course, the sole use of the remote computer may have its pros and cons as well such as loss of Internet connection and security issue as a result of malicious attacks from hackers are just two probable issues. Therefore, a mixed use of local and remote computer is suggested.

The local computer 164 in the automatic vending store 100 waits for the registered member to complete item selection on the selection menu. The item selected from the selection menu is stored into the storage of the local computer 164 for processing once the registered member has confirmed his order (item selection and quantity).

The local computer 164 in the automatic vending store 100 calculates the total amount payable. The tactile display screen 102 displays the total amount and presents the registered member with three payment option namely cash, payment card requiring PIN or payment with NFC technology which includes smart phone and card.

If the registered member had settled the payment, the purchased items and the amount spent will be associated with the registered member. After which, the transaction of the registered member ends. Conversely, if payment were not made, a countdown timer will be initiated. During this counting down, if there were no activation on the tactile display screen 102, the transaction will end.

The registered consumer can also perform the transaction using gesture and voice if the biometric information is recorded and saved in the local computer 164 at the vending machine or the biometric information is fetched from the remote computer.

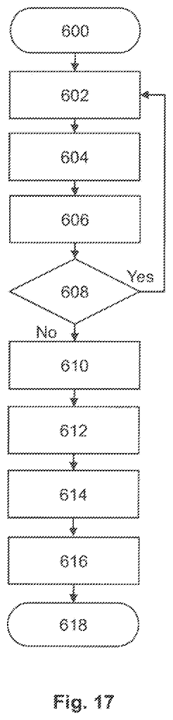

FIG. 17 illustrates a method of selecting the at least an item 600 including the following steps. A selection menu is displayed 602 on the tactile display screen 102. The item is selected 604 by the consumer using the tactile display screen 102. The quantity of the item is also selected 606. The local computer 164 prompts 608 consumer for more order on the tactile display screen 102 by a push button“Yes” or“No”. If the consumer selects“Yes”, the selection menu will be presented 602 again. This iteration will continue whenever the consumer touches the“Yes” button on the tactile display screen 102. Conversely, if the consumer pushed“No”, the total cost of the item will be computed 610 and displayed. The next step is to confirm payment 612. Once the payment is confirmed, the purchased item will be dispensed 614 and stored in the memory storage associating 616 with the consumer providing data for item suggestion in the next purchase. The selection of item ends 618.

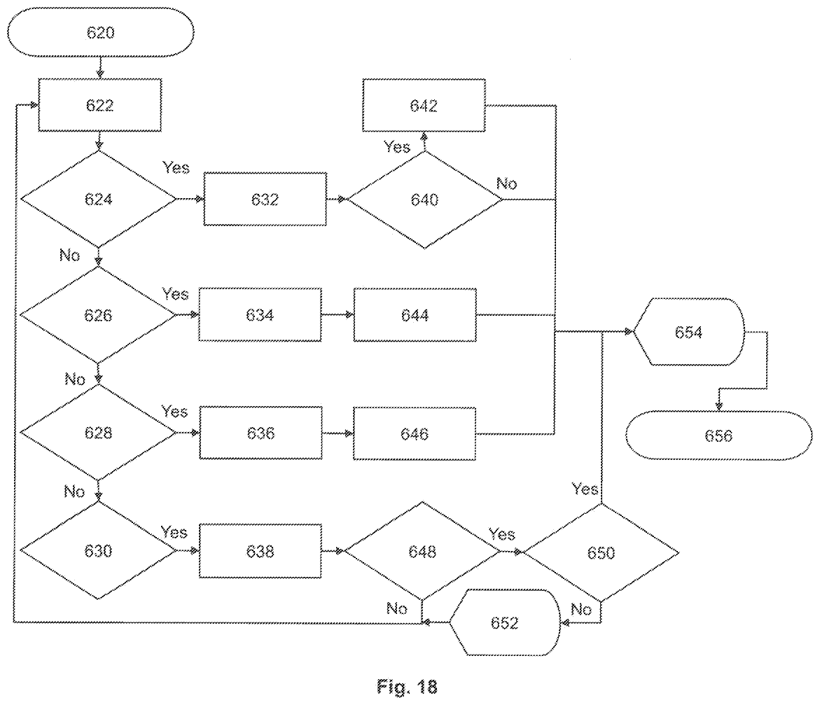

FIG. 18 illustrates a method of requesting payment 620 including the following steps. Presenting a payment button whereby the consumer touches the button on the tactile display screen 102. The consolidated cost of the order is shown 622 with applied tax or any other charges if any. The next step is to prompt the consumer for a preferred payment option, for example, cash, card or phone. If the consumer chose cash 624, the cash depositing unit with light emitting diodes will flash 632 to indicate the place to deposit the notes or coins. Change will be returned 640,642 if any. Other payment options using card could either use a payment card terminal for card insertion or swipe 644 where the display lit 634 or a reader module 120 which uses NFC for contactless card payment or smart phone payment 646 will be lit 636. The card can be credit card, debit card or card with smart chip (EMV chip).

An alternative payment method using facial recognition 630 including the steps of first tracking 638 for a human face in front of the automatic vending store 100. Secondly, determining 648 the human face as a registered consumer by searching at its remote server owned by the vending store owner. If the consumer's identity is confirmed, the total amount of the item purchased at the automatic vending store 100 will be deducted from the remaining value of the consumer's account. If there were not enough value 650 in the account. The transaction will be terminated. A message will be displayed 652 on the tactile display screen 102 “Insufficient value detected” accompanied by an audible alarm projected from the speakers 126. Conversely, if there were sufficient value in the consumer's account the remaining value will be reduced and the transaction approved. Thirdly, a positive result is returned to the automatic vending store 100. The tactile display screen 102 then displays “Payment made” 654. You have $3.00 remaining in your account.” That is the end of the payment process 656.

The current payment option is assumed that the automatic vending store 100 has an upfront payment policy at the point of first sales. In other words, the registered consumer has to buy a stipulated amount of value in the account like twenty dollars to kick start the purchase.

A method of monitoring the consumer's buying behaviour including the following steps. In order to monitor the consumer's buying behaviour, personal particulars have to be collected. The local computer 164 through the tactile display screen 102 acquires the particulars of the consumer including a photo image and a voice recording. The particulars of the consumer including a first name, a last name, a gender, a smart phone number, an electronic mail address and a date of birth. The purpose of storing a photo image and a voice recording is to prevent fraudulent use of the registered consumer's account. In particular, if the automatic vending store 100 business model were to issue a membership card with cash value in the card. The loss of the membership card equates to a loss in monetary value. Another reason for the collection of photo image is for data analysis in the facial recognition and voice recognition.

The submission of the consumer's personal particulars is stored in the local computer 164 or at a remote cloud with a flag to highlight that the consumer is a newly registered member and is entitled to a discount for the next purchase.

Incentive is given to the registered consumer, for example, a cash discount for any item purchased in the next purchase. However, the consumer has to scan the QR code displayed on the tactile display screen 102.

Information on the purchased item by the consumer is also stored in the local computer 164 or at a remote cloud. The information of the item which is the item specifications and other additional information like the storage section (freezer, chiller, ambient storage, shelf, compartment) and the dispensed date and time are stored. The consumer and the purchased item are associated by the local computer 164 algorithm.

For subsequent transactions by the consumer, the local computer 164 retrieves information of the consumer based on the facial or voice or both to commence transaction or scanning a membership card or smart phone with NFC technology on the reader module 120.

A method of identifying the consumer's facial features includes following steps. Firstly, the consumer's facial features are acquired from the photo image including the two eyes, a nose and lips. A plurality of images is scanned and detected for the mentioned features. The local computer 164 algorithm finds the position of the eyes based on the colour contrast between the sclera (white of the eye) and the surrounding skin. Once detected, the length of each eye is found, the distance between the two eyes are found and the distance from first distal end of the first eye to the second distal end of the second eye can be computed. The algorithm also finds the nose from the acquired image based on the distance relative to the eyes by looking for a colour contrast of the nostril and ala. The algorithm also finds the lips from the acquired image by detecting the lateral commissure or the two corners of the lips. To improve the feature recognition, the shape of the face and the facial hair are detected to identify the gender of the consumer.

A method of suggesting items based on the past buying behaviour and/or facial features and/or ambient temperature including retrieving past purchased items and suggesting the same item.

A method of controlling the sales of items based on a time condition. The time restriction is determined by the authority specifically on the sales of alcohol containing beverages after ten o'clock in the evening and resumes the sales the following day at ten in the morning. The algorithm in the local computer 164 can be set to forbid the sales of alcohol regardless of age based on the time.

During operation, the automatic vending store 100 can be accessed by the vending technician 118. The anthropomorphic robotic arms 142,146 are able to operate along the rail tacks 144,146 between the freezer 150, the chiller 152 to the ambient storage 154 without accessing the inventory storage 156. The only time the anthropomorphic robotic arms 142,146 access the rail tack 144,146 in front of the inventory storage 156 is when the vending technician 118 has finished replenishing the items and he manually activates the replenish sequence. The vending technician 118 may be able to activate the replenish sequence from his mobile device 202 without endangering his life after he has closed the access door 108.

In the application, unless specified otherwise, the terms “including”, “include”, and grammatical variants thereof, intended to represent “open” or “inclusive” language such that they include recited elements but also permit inclusion of additional, non-explicitly recited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain aspects may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

### REFERENCE NUMERALS

100 automatic vending store
102 tactile display screen
104 dispenser
106 payment terminal
108 access door
110 store length
112 store depth
114 store height
116 static advertisement section
118 vending technician
120 vending external camera
122 reader module
124 microphone
126 speaker
140 internal view of automatic vending store
142 lower anthropomorphic robotic arm
144 lower rail track
146 upper anthropomorphic robotic arm
148 upper rail track
150 freezer
152 chiller
154 ambient storage
156 inventory storage
158 automatic door
160 robot camera
162 end effector
164 local computer
166 pivotal trough
168 inclined plane
170 collection trough
172 table
174 grasping digits
190 a view of an ajar access door
192 tetra pack
194 bottle
196 pillow bag
198 vending camera
200 stocktaking
202 mobile device
204 shelf
206 shelf divider
208 compartment
210 label
212 front surface
214 top surface
216 barcode for IS1 S1 C1
218 detachable tray
220 strip of breadboard
222 photoelectric sensor
223 infrared senor
224 tray camera
226 conveyor belt
250 vending store modes of operation
252 store mode
254 detecting item
256 entering item specifications
258 dispensing item
260 tracking item
262 replenishing item
264 consumer mode
266 tracking eye
268 tracking gestures
270 recognizing voice
272 registering
274 selecting item
276 paying for item
278 identifying facial features 280 suggesting item
300 start of detecting item
302 photoelectric sensor disrupted?
304 freezer compartment?
306 chiller compartment?
308 ambient storage compartment?
310 inventory storage compartment?
312 adjusting quantity of item by 1
314 maximum quantity allowable?
316 recording quantity
318 end of detecting item
330 preparing a data file
332 entering vending store code
334 entering source compartment
336 entering target compartment
338 entering universal product code
340 entering brand
342 entering price
344 entering item type
346 entering best before date
348 entering country of origin
350 entering description
352 saving into memory storage
360 start of dispensing item
362 consumer selected an item?
364 reading data file from memory storage 366 activating the robotic arm
368 picking the item
370 signal of photoelectric sensor disrupted?
372 adjusting the quantity
374 depositing item in the pivotal trough
376 end of dispensing item
380 start of stocktaking
382 location based tracking
384 loading of data file into mobile device 386 scanning the UPC
388 display item location in the inventory storage
390 place items in the compartments of the inventory storage
392 manual input of physical quantity
394 photoelectric sensor signal disrupted?
396 counting disrupted signals of sensors at the inventory storage
398 is physical quantity equal to sensor count?
400 replace sensor at inventory storage
402 activate robotic arm
404 picks up item from inventory storage to the appropriate compartment
406 end of stocktaking
410 start of arranging items
412 are sensors disrupted in the inventory storage?
414 reading data file from memory storage
416 any item in the target compartment?
418 pick the item(s) out from the target compartment and place at temporary inventory storage
420 pick the item from the source (Inventory Storage) to the target compartment. 422 any item in the source compartment?
424 pick the item(s) from the temporary inventory storage to the target compartment 426 exceed limit in target compartment?
428 sending message to mobile device“Not enough space”
430 end of arranging items
440 Start of detecting temperature
442 Acquiring a temperature from the base
444 Acquiring a temperature from the top
446 Average of the two readings
448 Temp <20C?
450 Temp >30C?
452 Suggest warm item
454 Suggest cold item
460 start of eye tracking
462 human face?
464 Locating the eyes
466 Locating the iris and sclera
468 Tracking the eye
470 Look right?
472 look left?
474 Scroll the selection menu to the right 476 Scroll the selection menu to the left
478 Double blink?
480 Confirm selection
482 End of eye tracking
490 start of hand tracking
492 human face?
494 locating the hand or pointed finger
496 finger scrolling left?
498 finger scrolling right?
500 finger scrolling up?
502 finger scrolling down?
504 grip?
506 open palm?
508 display scrolls left
510 display scrolls right
512 display scrolls up
514 display scrolls down
516 confirm selection
518 deselect
530 start of voice recognition
532 identifying the harmonics of the human voice
534 voice match?
536 vending store initiated voice
538 corresponding item label called?
540 confirm selection?
542 Add more item?
544 Add into shopping cart
546 pay for item(s)?
548 payment
550 end of voice recognition
560 start of member registration
562 tactile input on screen?
564 voice?
566 eye?
568 enter last name, first name
570 enter gender
572 enter birth date
574 enter mobile phone number
576 enter email
578 photo taking of new member
580 voice recording of new member
582 Vending store initiated voice instruction
584 Same information acquired as tactile input
586 Verification to phone
588 Enter verification message in vending store
590 end of member registration
600 start of item selection
602 Display selection menu
604 Consumer selects item
606 Consumer enters quantity
608 more item?
610 Total cost
612 Total cost
614 Dispense item(s)
616 Associate item(s) with consumer
618 End of item selection
620 start of requesting payment
622 Display total cost of item(s)\
624 cash payment?
626 card payment?
628 Contactless payment?
630 facial?
632 LED flashes at cash slot
634 LED lit at payment terminal
636 LED lit at reader module
638 Tracking a human face
640 change?
642 Dispense change
644 Insert or swipe card 646 wave card or mobile phone 648 Member?
650 Enough value in account? 652 Insufficient value
654 Payment made
656 end of requesting payment

1. An automatic vending store for offering goods of sales, the automatic vending store comprising:
a first storage compartment for keeping some goods of sales;
a second storage compartment for keeping additional goods of sales;
a payment terminal that is connected to at least one of the first storage compartment and the second storage compartment for transacting the goods of sales automatically; and
an automatic organizer for moving the goods of sales between the first storage compartment and the second storage compartment;
wherein the automatic organizer comprises an automatic loader for replenishing or loading the goods of sales onto the first storage compartment.

2. The automatic vending store of claim 1, wherein
the automatic organizer comprises a robot for replenishing the goods of sales onto at least one of the storage compartments.

3. The automatic vending store of claim 1 further comprising at least one camera for monitoring operation of the automatic vending store.

4. The automatic vending store of claim 3, wherein
the camera comprises an optical character reader.

5. The automatic vending store of claim 1, wherein
the first storage compartment comprises a storing shelve for holding the goods of the sales, and the second storage compartment comprises a transferring shelf for tallying the goods of sales.

6. The automatic vending store of claim 1, wherein
the first storage compartment comprises at least one thermally insulated chamber for keeping the goods of sales at substantially constant temperatures.

7. The automatic vending store of claim 6, wherein
the at least one thermally insulated chamber comprises an access door.

8. The automatic vending store of claim 1 further comprising
a moisture absorber for removing water vapor inside the automatic vending store.

9. The automatic vending store of claim 1 further comprising:
a computer having at least one user interface for operating the automatic vending store.

10. The automatic vending store of claim 9, wherein
the at least one user interface comprises multiple terminals for accessing
the automatic vending store by multiple users simultaneously.

11. The automatic vending store of claim 1 further comprising
a communication unit for communicating with an external electronic communication device.

12. The automatic vending store of claim 1 further comprising
a hub connector for bundling signal wires, power cables or both together.

13. The automatic vending store of claim 1 further comprising
a local energy source for powering the automatic vending store.

14. The automatic vending store of claim 1 further comprising
a window for exposing the goods to a customer by the automatic organizer.

15. The automatic vending store of claim 1 further comprising
a timer for regulating operation of the automatic vending store according to time.

16. A method of using an automatic vending store, the method comprising:
providing an automatic vending store;
loading a first storage compartment of the automatic vending store with goods of sales;
moving at least one of the goods of sales from the first storage compartment to a second storage compartment of the automatic vending store in the absence of sales or delivery to a customer automatically for tallying; and
retrieving goods from any of the storage compartments for dispensing to a customer at a dispenser for retrieving by a customer.

17. The method of claim 16, wherein
the moving at least one of the goods of sales comprises tallying the goods of sales.

18. The method of claim 16 further comprising
examining identify information of a user; and
deciding on whether to grant access to the user.

19. The method of claim 16 further comprising
sending message to a remote electronic device for replenishing the goods of sales.

20. The method of claim 16 further comprising
transferring goods between a first automatic organizer and a second automatic organizer of the automatic vending machine.
